(19) United States
(12) Patent Application Publication
(10) Pub. No.: US 2023/0343497 A1
(43) Pub. Date: Oct. 26, 2023

(54) METAL MAGNETIC POWDER, COMPOSITE MAGNETIC BODY, AND ELECTRONIC COMPONENT

(71) Applicant: TDK CORPORATION, Tokyo (JP)

(72) Inventors: Kyohei TAKAHASHI, Tokyo (JP); Hiroshi ITO, Tokyo (JP); Isao KANADA, Tokyo (JP); Kazuhiro YOSHIDOME, Tokyo (JP)

(73) Assignee: TDK CORPORATION, Tokyo (JP)

(21) Appl. No.: 18/302,270

(22) Filed: Apr. 18, 2023

(30) Foreign Application Priority Data
Apr. 21, 2022 (JP) 2022-070119

(51) Int. Cl. H01F 1/08

(52) U.S. Cl. CPC H01F 1/083; B82Y 30/00

(57) ABSTRACT

A metal magnetic powder contains Co as a main component, and the metal magnetic powder includes metal nanoparticles having a mean particle size (D50) of 1 nm or more and 100 nm or less. Each of the metal nanoparticles includes hcp-Co as a main phase, and the metal magnetic powder includes fcc-Co and/or ε-Co as a sub-phase.

### TECHNICAL FIELD

The present disclosure relates to a metal magnetic powder containing metal nanoparticles including Co as a main component, a composite magnetic body, and an electronic component.

### BACKGROUND

In recent years, operation frequencies range up to a gigahertz band (for example, 3.7 GHz band (3.6 to 4.2 GHz) and 4.5 GHz band (4.4 to 4.9 GHz band)), in high-frequency circuits included in various communication devices, such as a mobile phone and a wireless LAN device. Examples of electronic components mounted on such high frequency circuits include an inductor, an antenna, and a filter for high frequency noise suppression. Although an air-core coil having a non-magnetic core is generally used as a coil incorporated in such electronic components for high frequency applications, there is a demand for development of a magnetic material applicable to the electronic components for high frequency applications in order to improve properties of the electronic components.

For example, Patent Document 1 discloses a magnetic material made of metal nanoparticles for high frequency applications. The metal nanoparticles can reduce the number of magnetic domains per unit particle as compared with micrometer-order metal magnetic particles, and can reduce the eddy current loss in the high frequency band. However, even in the magnetic material disclosed Patent Document 1, when the operating frequency exceeds 1 GHz, the permeability extremely decreases (FIG. 2 of Patent Document 1), and the magnetic loss increases.

Patent Document 1: JP 2006303298 A

### SUMMARY

The present disclosure has been made in view of the above circumstances, and an object thereof is to provide a metal magnetic powder having a high permeability and a low magnetic loss in a high frequency region of a gigahertz band, and a composite magnetic body and an electronic component which contain the metal magnetic powder.

In order to achieve the above object, a metal magnetic powder according to the present disclosure includes Co as a main component,
wherein the metal magnetic powder comprises metal nanoparticles having a mean particle size (D50) of 1 nm or more and 100 nm or less,
wherein each of the metal nanoparticles comprises hcp-Co as a main phase, and
wherein the metal magnetic powder includes fcc-Co and/or ε-Co as a sub-phase.

Since the metal magnetic powder of the present disclosure has the above characteristics, it is possible to obtain both the high permeability and the low magnetic loss in the high frequency region of the gigahertz band.

Preferably, W_{hcp}/(W_{hcp}+W_{fcc}+W_{ε}) is 70% or more and 99% or less,
where W_{hcp} denotes a proportion of the hcp-Co, W_{fcc} denotes a proportion of the fcc-Co, and W_{ε} denotes a proportion of the ε-Co, in the metal magnetic powder.

Preferably, the metal nanoparticles have a mean particle size (D50) of 1 nm or more and 70 nm or less.

Preferably, the metal magnetic powder further includes Zn, and
Zn is present on a surface and/or inside of at least one of the metal nanoparticles.

A composite magnetic body according to the present disclosure includes the metal magnetic powder and a resin.

Since the composite magnetic body includes the metal magnetic powder, it is possible to suitably achieve both the high permeability and the low magnetic loss in the high frequency region of the gigahertz band.

Preferably, the composite magnetic body further includes Zn.

The metal magnetic material and the composite magnetic body described above can be suitably used in electronic components such as an inductor, an antenna, and a filter mounted on a high frequency circuit.

### BRIEF DESCRIPTION OF THE DRAWINGS

FIG. 1 is a schematic diagram illustrating a metal magnetic powder 1 according to an embodiment of the present disclosure;

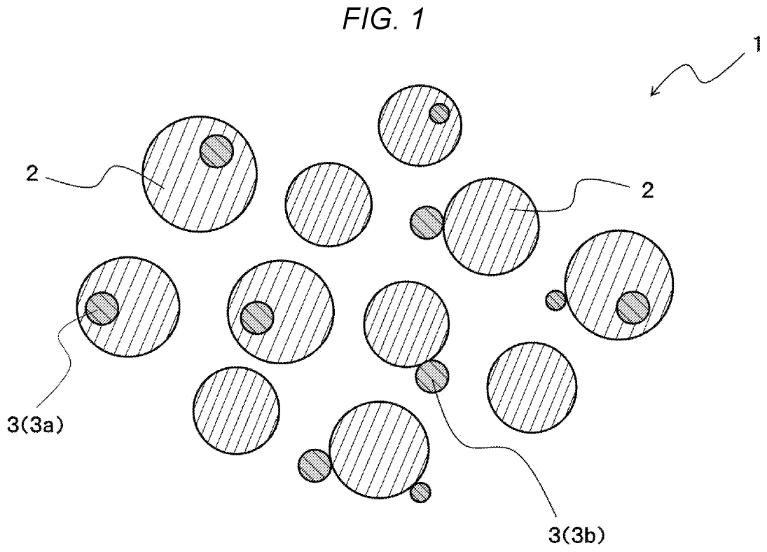

FIG. 2 is a schematic diagram illustrating a cross section of a composite magnetic body containing the metal magnetic powder 1 illustrated in FIG. 1;

FIG. 3A is an example of an X-ray diffraction pattern of the metal magnetic powder 1;

FIG. 3B is an example of an X-ray diffraction pattern of the metal magnetic powder 1 including Zn; and

FIG. 4 is a schematic diagram of a cross-section illustrating an example of an electronic component containing a composite magnetic body 10 illustrated in FIG. 2.

### DETAILED DESCRIPTION

Hereinafter, the present disclosure is described in detail on the basis of an embodiment shown in the figures.

### (Metal Magnetic Powder 1)

A metal magnetic powder 1 according to the present embodiment is comprised of nanoparticles 2 (metal nanoparticles). A mean particle size of the nanoparticles 2 (that is, a mean particle size of the metal magnetic powder 1) is 1 nm or more and 100 nm or less. The mean particle size of the nanoparticles 2 may be calculated by measuring an equivalent circular diameter of each of the nanoparticles 2 using a transmission electron microscope (TEM). Specifically, the metal magnetic powder 1 is observed with the TEM at a magnification of 500,000 times or more, and the equivalent circular diameter of each of the nanoparticles 2 included in an observation field of view is measured with image analysis software. At this time, it is preferable to measure equivalent circular diameters of at least 500 nanoparticles 2, and a cumulative frequency distribution on a number basis is obtained based on the measurement results. Then, an equivalent circular diameter at which the cumulative frequency is 50% in the cumulative frequency distribution is calculated as the mean particle size (D50) of the nanoparticles 2.

The mean particle size (D50) of the nanoparticles 2 is preferably 70 nm or less, and more preferably 50 nm or less. As the mean particle size of the nanoparticles 2 is reduced, a magnetic loss tanδ of the metal magnetic powder 1 tends to be further reduced. Although shapes of the nanoparticles 2 are not particularly limited, manufacturing methods shown in the present embodiment usually yields the nanoparticles 2 having spherical shapes or shapes close to sphere. In addition, each surface of the nanoparticles 2 may have a coating such as an oxide layer or an insulating layer.

The metal magnetic powder 1 includes cobalt (Co) as a main component. That is, the nanoparticles 2 are Co nanoparticles including Co as the main component. Note that the “main component” means an element occupying 80 wt % or more in the metal magnetic powder 1. The metal magnetic powder 1 preferably includes 90 wt % or more of Co, more preferably 93 wt % or more of Co.

The metal magnetic powder 1 preferably includes at least one amphoteric metal in addition to Co. The amphoteric metals means four elements of aluminum (Al), zinc (Zn), tin (Sn), and lead (Pb), and the metal magnetic powder 1 more preferably includes Zn as the amphoteric metal. W_{AM}/(W_{Co}+W_{AM}) is preferably 0.001% or more (10 ppm or more) and 10% or less, and more preferably 1% or more and 7% or less, where W_{Co} (wt %) denotes a content rate of Co in the metal magnetic powder 1 and W_{AM} (wt %) denotes a content rate of the amphoteric metals in the metal magnetic powder 1. In a case where the metal magnetic powder 1 includes two or more amphoteric metals, W_{AM} is a sum of content rates of the amphoteric metals.

The metal magnetic powder 1 may include other trace elements such as Cl, P, C, Si, N, and O. A total content rate of the other trace elements (elements other than Co and amphoteric metals) in the metal magnetic powder 1 is preferably 20 wt % or less.

A composition (W_{Co}, W_{AM}, W_{AM}/(W_{Co}+W_{AM}), or the like) of the metal magnetic powder 1 can be measured by composition analysis using, for example, inductively coupled plasma atomic emission spectrometry (ICP-AES), X-ray diffraction (XRD), X-ray fluorescence spectrometry (XRF), energy dispersive X-ray spectrometry (EDS), wavelength dispersive X-ray spectrometry (WDS), or the like, and is preferably measured by ICP-AES. In the composition analysis by ICP-AES, first, a sample containing the metal magnetic powder 1 is collected in a glove box, and the sample is added to an acid solution such as HNO₃ (nitric acid), and heated and melt. The composition analysis by ICP-AES may be performed using this solutionized sample to quantify Co and each amphoteric metal contained in the sample.

Note that the main component of the metal magnetic powder 1 may be identified on the basis of analysis of X-ray diffraction or the like. For example, a volume ratio of each element contained in the metal magnetic powder 1 may be calculated by analysis of X-ray diffraction or the like, and an element having the highest volume ratio may be identified as the main component of the metal magnetic powder 1.

A main phase of the metal magnetic powder 1, that is, a main phase of each of the nanoparticles 2 is hcp-Co. This “hcp-Co” means not an alloy phase but a crystalline phase of Co having a hexagonal close-packed structure. Co with massive shape and Co particles with micrometer-order particle size tend to have the hcp structure, but when Co particles have a particle size of 100 nm or less, the main phase tends to be fcc-Co (face-centered cubic structure) or ε-Co (a type of cubic crystal). In the present embodiment, the nanoparticles 2 whose main phase is hcp-Co are obtained by predetermined manufacturing methods to be described later.

In addition, the metal magnetic powder 1 includes fcc-Co and/or ε-Co as a sub-phase of Co in addition to hcp-Co as the main phase. This sub-phase of Co is present within the nanoparticles 2 along with the main phase of hcp-Co. That is, the metal magnetic powder 1 includes the nanoparticles 2 having a mixed-phase structure of Co (a structure including the main phase and the sub-phase inside the particles) rather than mixing of the single-phase nanoparticles 2 having hcp-Co and the other single-phase nanoparticles having fcc-Co or ε-Co. In the metal magnetic powder 1, all the nanoparticles 2 may have the mixed-phase structure, or the nanoparticles 2 having hcp-Co (the nanoparticles 2 not including the sub-phase of Co) and the nanoparticles 2 having the mixed-phase structure (nanoparticles 2 including the sub-phase of Co) may be present together. Among the nanoparticles 2 of the metal magnetic powder 1, 80% or more of the nanoparticles 2 on the number basis preferably have the mixed-phase structure.

Since the metal magnetic powder 1 includes the sub-phase of Co inside the nanoparticles 2, it is possible to reduce a magnetic loss as compared with the related art while ensuring a high permeability in a high frequency band of 1 GHz or higher.

Note that the “main phase” means a crystalline phase occupying 50% or more of the metal magnetic powder 1. Specifically, a proportion of hcp-Co is W_{hcp}, a proportion of fcc-Co is W_{fcc}, a proportion of ε-Co is W_{ε}, and W_{hcp}+W_{fcc}+W_{ε} is 100% in the metal magnetic powder 1, a crystalline phase occupying 50% or more is defined as the main phase. That is, it is determined that the main phase of the metal magnetic powder 1 is hcp-Co when 50%≤(W_{hcp}/(W_{hcp}+W_{fcc}+W_{ε})) is satisfied. “W_{hcp}/(W_{hcp}+W_{fcc}+W_{ε})” denoting a content ratio of hcp-Co is preferably 70% or more and 99% or less, and more preferably 80% or more and 99% or less. When the content ratio of hcp-Co is set within the above range, it is possible to more suitably achieve both the high permeability and the low magnetic loss.

The metal magnetic powder 1 may include either fcc-Co or ε-Co, or may include both fcc-Co and ε-Co, as the sub-phase of Co.

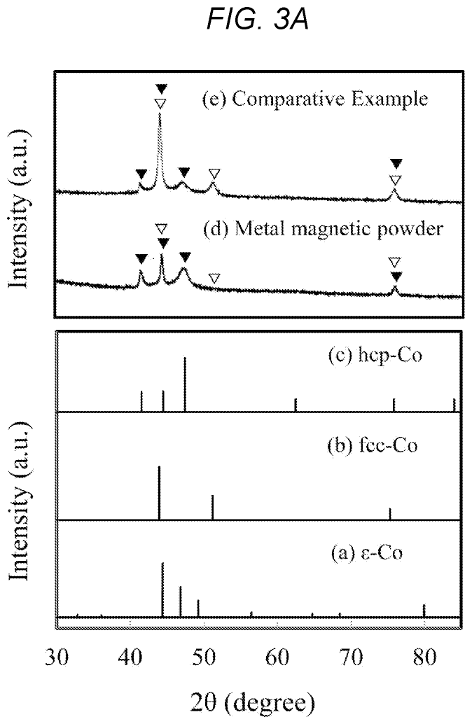

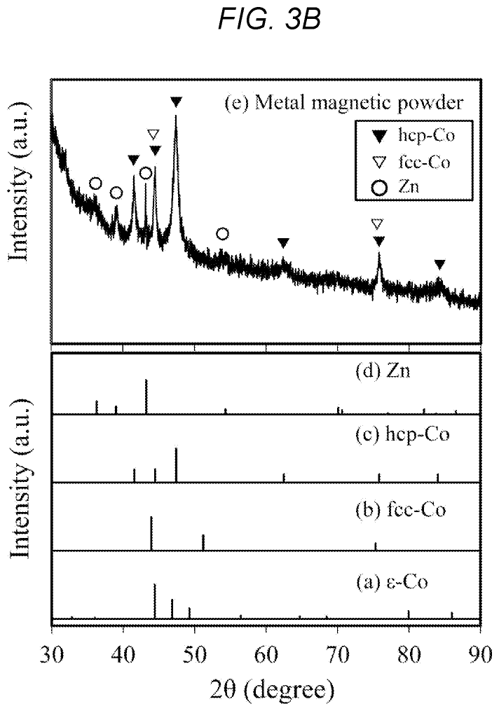

A crystal structure of the metal magnetic powder 1 (that is, a crystal structure of the nanoparticles 2) can be analyzed by X-ray diffraction (XRD). In FIG. 3A, (d) is an example of an XRD pattern of the metal magnetic powder 1. Note that (a) to (c) in FIG. 3A are all XRD patterns stored in databases such as documents or ICDD, in which (a) is the XRD pattern of ε-Co, (b) is the XRD pattern of fcc-Co, and (c) is the XRD pattern of hcp-Co. In addition, (e) in FIG. 3A is an example of an XRD pattern of a metal magnetic powder corresponding to Comparative Example.

The XRD pattern of the metal magnetic powder 1 as shown in (d) of FIG. 3A is obtained by 2θ/θ measurement of XRD, and then, profile fitting (peak separation) of the measured XRD pattern is performed using XRD analysis software. Then, crystalline phases included in the metal magnetic powder 1 can be identified by collating separated diffraction peaks with the database. In the XRD pattern shown in (d) of FIG. 3A, peaks indicated by “▾” are diffraction peaks derived from hcp-Co, and peaks indicated by “∇” are diffraction peaks derived from fcc-Co.

In addition, the proportion of each Co crystalline phase may be calculated on the basis of an integrated intensity of each diffraction peak. Specifically, the diffraction peaks included in the XRD pattern (d) are identified by profile fitting, and then, integrated intensities of the identified diffraction peaks are calculated. W_{hcp} is an integrated intensity of diffraction peaks derived from hcp-Co, W_{fcc} is an integrated intensity of diffraction peaks derived from fcc-Co, and W_{ε} is an integrated intensity of diffraction peaks derived from ε-Co, and “W_{hcp}/(W_{hcp}+W_{fcc}+W_{ε})” can be calculated.

In the XRD pattern (d) of FIG. 3A, diffraction peaks of hcp-Co and diffraction peaks of fcc-Co are detected, a content ratio of hcp-Co (W_{hcp}/(W_{hcp}+W_{fcc}+W_{ε})) is 95.1%, and a content ratio of fcc-Co (W_{fcc}/(W_{hcp}+W_{fcc}+W_{ε})) is 4.9%. That is, in the metal magnetic powder 1 in (d) of FIG. 3A, the main phase is hcp-Co, and the sub-phase is fcc-Co.

In the XRD pattern (e) of FIG. 3A corresponding to Comparative Example as well, diffraction peaks of hcp-Co and diffraction peaks of fcc-Co are detected, but peak intensities around 2θ=43.9° and around 51.2° in the XRD pattern (e) are higher than those in the XRD pattern (d). More specifically, in the XRD pattern (e), a content ratio of hcp-Co (W_{hcp}/(W_{hcp}+W_{fcc}+W_{ε})) is 38.6%, and a content ratio of fcc-Co (W_{fcc}/(W_{hcp}+W_{fcc}+W_{ε})) is 61.4%. That is, in the metal magnetic powder according to Comparative Example in (e) of FIG. 3A, the main phase is fcc-Co, and the sub-phase is hcp-Co.

In hcp-Co which is the main phase of the metal magnetic powder 1, the amphoteric metals and impurity elements may be slightly solid-dissolved. However, the degree of deviation of a lattice constant of hcp-Co is preferably 0.5% or less. The “degree of deviation of the lattice constant” is represented by (|d_{STD}−d_{f}|)/d_{STD} (%), where d_{STD} denotes a lattice constant of hcp-Co stored in the database, and d_{f} denotes a lattice constant of hcp-Co calculated by analyzing an XRD pattern of the metal magnetic powder 1. The lattice constant may be measured by electron diffraction using a TEM.

In addition, the presence or absence of the mixed-phase structure in the nanoparticles 2 can be confirmed by analysis using the TEM, such as high-resolution transmission electron microscopy (HRTEM), electron backscatter diffraction (EBSD), or electron diffraction. For example, in a case where a crystal structure of each of the nanoparticles 2 is analyzed by electron diffraction using the TEM, at least 50 nanoparticles 2 are irradiated with an electron beam, and whether each of the nanoparticles 2 has a single-phase structure or the mixed-phase structure is determined on the basis of an electron diffraction pattern obtained at that time. In the analysis, it is preferable to select the nanoparticles 2 isolated in the field of view as much as possible and to irradiate the selected nanoparticles with the electron beam.

Note that a crystal structure of the nanoparticles 2 may be identified first by electron diffraction using the TEM, and then, content ratios of the Co crystalline phases may be calculated by XRD with reference to the analysis result of the electron diffraction in the analysis of the crystal structure of the metal magnetic powder 1.

In a case where the metal magnetic powder 1 includes the amphoteric metal, the amphoteric metal is preferably present as crystal grains 3 of the amphoteric metal rather than being solid-dissolved in the main phase (hcp-Co) or included in compounds such as oxides. In other words, the metal magnetic powder 1 preferably includes the crystal grains 3 of the amphoteric metal, and particularly, more preferably includes Zn crystal grains (3).

In a case where the metal magnetic powder 1 includes the crystal grains 3 of the amphoteric metal, not only the diffraction peaks of the Co crystalline phases but also diffraction peaks of the amphoteric metal are detected in an XRD pattern of the metal magnetic powder 1. Actually, (e) in FIG. 3B is an example of the XRD pattern of the metal magnetic powder 1 containing Zn as the amphoteric metal. Note that (a) to (c) in FIG. 3B show diffraction peaks of each of the Co crystalline phases stored in the databases such as documents or ICDD similarly to FIG. 3A, and (d) in FIG. 3B shows diffraction peaks of Zn stored in the database.

In the XRD pattern (e) of FIG. 3B, diffraction peaks of Zn are detected together with diffraction peaks of hcp-Co (peaks indicated by “○” are the diffraction peaks of Zn). That is, it is found that Zn is present not as a compound such as an oxide but as metal crystals in the metal magnetic powder 1 shown in (e) of FIG. 3B. In this manner, an existence state of the amphoteric metals can be confirmed by the analysis of the XRD pattern.

In addition, in the case where the metal magnetic powder 1 includes the amphoteric metal, the amphoteric metal is preferably present on a surface and/or inside of at least one of the nanoparticles 2. Specifically, the nanoparticles 2 preferably comprise some nanoparticles 2 having the amphoteric metal on the surface and/or some nanoparticles 2 having the amphoteric metal inside. That is, the metal magnetic powder 1 preferably includes, as the crystal grains 3 of the amphoteric metal, crystal grains 3a present insides some nanoparticles 2 and/or crystal grains 3b adhering to the surfaces of some nanoparticles 2. In addition, grain sizes of the crystal grains 3 are preferably smaller than the mean particle size of the nanoparticles 2. Existing locations of the amphoteric metal can be identified by, for example, mapping analysis using TEM-EDS.

### (Composite Magnetic Body 10)

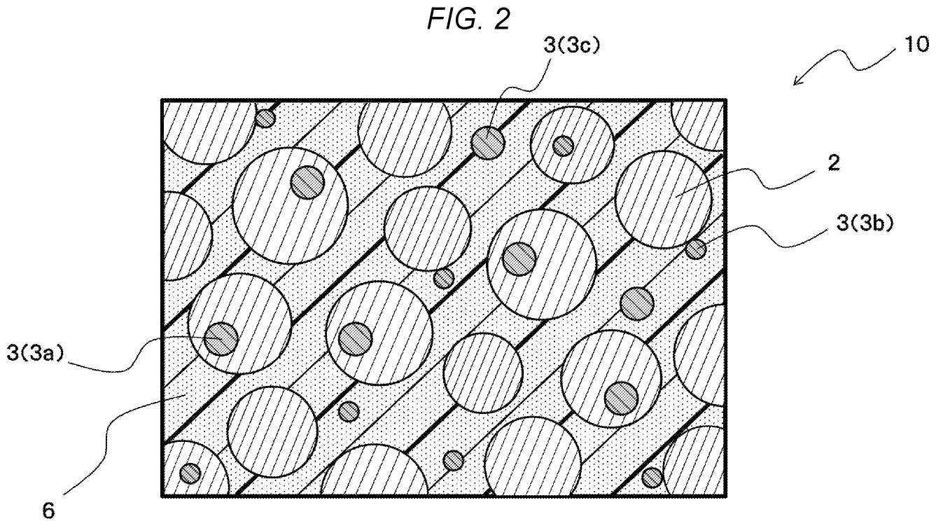

Next, a composite magnetic body 10 including the above-described metal magnetic powder 1 is described with reference to FIG. 2.

The composite magnetic body 10 includes the metal magnetic powder 1 having the above-described characteristics and a resin 6, and the nanoparticles 2 comprising the metal magnetic powder 1 are dispersed in the resin 6. In other words, the resin 6 is interposed between the nanoparticles 2 to insulate adjacent particles from each other. A material of the resin 6 is not particularly limited as long as a resin material having insulating properties is used. For example, a thermosetting resin such as an epoxy resin, a phenol resin, or a silicone resin, or a thermoplastic resin such as an acrylic resin, polyethylene, or polypropylene can be used as the resin 6, and the thermosetting resin is preferable.

An area ratio of the metal magnetic powder 1 in a cross section of the composite magnetic body 10 is preferably 10% to 60%, and more preferably 10% to 40%.

The area ratio of the metal magnetic powder 1 in the cross section of the composite magnetic body 10 can be calculated by observing the cross section of the composite magnetic body 10 using a scanning electron microscope (SEM) or a transmission electron microscope (TEM), and analyzing cross-sectional images using image analysis software. Specifically, the cross-sectional images of the composite magnetic body 10 may be binarized based on contrast, and distinguish the metal magnetic powder 1 from the other part. Then, the ratio of the area occupied by the metal magnetic powder 1 with respect to the entire images (that is, a ratio of a total area of the nanoparticles 2 to a total area of the observed field of views) may be calculated from the binarized cross-sectional images. The area ratio calculated by the above method can be regarded as a volume ratio of the nanoparticles 2 in the composite magnetic body 10.

In a case where the metal magnetic powder 1 includes the amphoteric metal, the amphoteric metal is preferably present as the crystal grains 3 inside the composite magnetic body 10. More specifically, the composite magnetic body 10 may include the crystal grains 3a that are present insides some nanoparticles 2 and/or crystal grains 3b adhering to surfaces of some nanoparticles 2. In addition, the composite magnetic body 10 may include crystal grains 3c that are dispersed in the resin 6 of the composite magnetic body 10, as the crystal grains 3. It is considered that some of the crystal grains 3b adhering to the surfaces of the nanoparticles 2 detach from the surfaces during the process of mixing the metal magnetic powder 1 and the resin 6, resulting in the production of the crystal grains 3c.

That is, examples of existing locations of the amphoteric metal in the composite magnetic body 10 include three patterns: the insides of some nanoparticles 2 of A; the surface of some nanoparticles 2 of B; and in the resin 6 of C. The amphoteric metal in the composite magnetic body 10 may be present in any one pattern of A to C, may be present in any two patterns of A to C, or may be present in all the sites of A to C. The existing locations of the amphoteric metal in the composite magnetic body 10 can be identified by performing mapping analysis using TEM-EDS on the cross section of the composite magnetic body 10.

Even in the case where the metal magnetic powder 1 is included in the composite magnetic body 10, the mean particle size (D50), composition, and crystal structure of the metal magnetic powder 1 can be analyzed by the above-described method (TEM observation, ICP-AES, XRD, or the like). Note that there is a case where an analysis result is affected by a constituent element of the resin 6 when the composition of the metal magnetic powder 1 in the composite magnetic body 10 is analyzed by ICP-AES, XRD, or the like. In such a case, the influence of elements other than Co and the amphoteric metals may be eliminated, and a main component of the metal magnetic powder 1 may be identified only on the basis of W_{AM}/(W_{Co}+W_{AM}).

The composite magnetic body 10 may include ceramic particles, metal particles other than the nanoparticles 2, and the like. In addition, a shape and a dimension of the composite magnetic body 10 are not particularly limited, and may be appropriately determined according to an application.

Hereinafter, examples of methods for manufacturing the metal magnetic powder 1 and the composite magnetic body 10 is described. The metal magnetic powder 1 of the present embodiment is preferably manufactured by a vapor phase thermal decomposition method or a liquid phase thermal decomposition method involving a disproportionation reaction.

### (Method for Manufacturing Metal Magnetic Powder 1 by Vapor Phase Thermal Decomposition Method)

A thermal decomposition method is a method for producing Co nanoparticles by heating and thermally decomposing a cobalt complex which is a precursor. In general, the precursor is dispersed in a solvent such as dichlorobenzene or ethylene glycol, and a reaction solution is heated to a high temperature of about 180° C. to thermally decompose the precursor in a liquid phase (i.e., a liquid phase thermal decomposition method). In the present embodiment, the precursor is thermally decomposed in a vapor phase of an inert atmosphere without using a solvent (i.e., a vapor phase thermal decomposition method). A main phase of nanoparticles is likely to be fcc-Co or ε-Co in the related-art liquid phase thermal decomposition method, whereas the nanoparticles 2 whose main phase is hcp-Co can be obtained in the vapor phase thermal decomposition method.

In the vapor phase thermal decomposition method, a reaction vessel into which the precursor as a raw material has been input is placed in an oil bath, and the reaction vessel is heated in the inert atmosphere to thermally decompose the precursor. At this time, the raw material in the reaction vessel is stirred using a mechanical stirrer or the like. As the cobalt complex which is the precursor, octacarbonyldicobalt (Co₂(CO)₈) or Co₄(CO)₁₂ is preferably used, and Co₂(CO)₈ is more preferably used. As the reaction vessel, for example, a separable flask can be used, and a material of the reaction vessel is not particularly limited. In addition, the thermal decomposition atmosphere is filled with the inert gas such as Ar gas or N₂ gas, and a type of the inert gas to be used is not particularly limited.

In a case where the amphoteric metal is added to the metal magnetic powder 1, a raw material of the amphoteric metal may be put into the reaction vessel together with the precursor. As the raw material of the amphoteric metal, for example, chlorides of amphoteric metals such as ZnCl₂, AlCl₃, SnCl₂, and PbCl₂ are preferably used. The content ratio of the amphoteric metal (W_{AM}/(W_{AM}+W_{Co})) in the metal magnetic powder 1 can be controlled by compounding ratios of the raw materials. In addition, a surfactant such as oleic acid or a silane coupling agent may be added during a thermal decomposition reaction. As the silane coupling agent, for example, a silane coupling agent containing an aniline structure and/or a phenyl group is preferably used, and N-phenyl-3-aminopropyltrimethoxysilane is more preferably used.

In a case where no surfactant is added, a reaction temperature in the vapor phase thermal decomposition method (that is, a heating temperature of the raw materials) can be set to 57° C. or higher and 180° C. or lower, and is preferably 57° C. or higher and 120° C. or lower, and more preferably 57° C. or higher and 80° C. or lower. On the other hand, in a case where a surfactant is added, the reaction temperature can be set to 52° C. or higher and 150° C. or lower, and is preferably 57° C. or higher and 120° C. or lower, and more preferably 57° C. or higher and 80° C. or lower. As the reaction temperature is raised, a mean particle size of the nanoparticles 2 tends to increase. When the reaction temperature is low, the mean particle size of the nanoparticles 2 decreases, and the content ratio of hcp-Co tends to increase.

It is desirable to appropriately adjust a reaction time in the vapor phase thermal decomposition method according to the reaction temperature. For example, the reaction time is preferably 0.01 h to 3.5 h when the reaction temperature is 150° C. to 180° C., the reaction time is preferably 0.1 h to 10 h when the reaction temperature is 100° C. or higher and lower than 150° C. When the reaction temperature is lower than 100° C., the reaction time is preferably 0.25 h to 96 h, and more preferably 1 h to 50 h. As the reaction time is increased, the mean particle size of the nanoparticles 2 tends to increase.

A crystal structure of the nanoparticles 2 can be controlled by a type of surfactant, the reaction temperature, and the like. For example, in the case where no surfactant is added, fcc-Co is more likely to be produced as the sub-phase when the reaction temperature is raised. In a case where oleic acid is added as the surfactant, ε-Co is likely to be produced as the sub-phase, and the content ratio of ε-Co tends to increase when the reaction temperature is raised. On the other hand, in a case where N-phenyl-3-aminopropyltrimethoxysilane as the silane coupling agent is added as the surfactant, both fcc-Co and ε-Co are likely to be obtained as the sub-phases, and a content ratio of the sub-phases increases when the reaction temperature is raised.

In the case where the amphoteric metal is added to the metal magnetic powder 1, the raw material of the amphoteric metal may be added at the start of the reaction, or may be added after a lapse of a predetermined time from the start of the reaction. The existing locations of the amphoteric metal can be controlled by a timing of adding the raw material of the amphoteric metal. Specifically, when the raw material of the amphoteric metal is added at the start of the reaction, the amphoteric metal is likely to be present inside the nanoparticles 2. On the other hand, when the raw material of the amphoteric metal is added in the middle of the thermal decomposition reaction, the amphoteric metal adheres to the surfaces of the nanoparticles 2, and a proportion of the amphoteric metal present on the surfaces of the nanoparticles 2 tends to increase as the timing of adding the raw material of the amphoteric metal is delayed. Specifically, when the raw material of the amphoteric metal is added after a lapse of (2/3) RT or more from the start of the reaction assuming a final reaction time as RT, the amphoteric metal tends to be present on the surfaces of the nanoparticles 2 rather than inside the particles.

After the thermal decomposition reaction in the vapor phase is continued for a desired time, the reaction vessel is removed from the oil bath and naturally cooled until a product reaches a room temperature. After the cooling, the produced nanoparticles 2 are washed using a washing solvent and collected. As the washing solvent, for example, an organic solvent such as acetone, dichlorobenzene, or ethanol can be used, and it is preferable to subject the washing solvent to a degassing treatment in order to suppress oxidation of the nanoparticles 2. Alternatively, it is preferable to use a super-dehydrated-grade organic solvent having a moisture amount of 10 ppm or less as the washing solvent. Note that a magnet may be used to collect the nanoparticles 2. The metal magnetic powder 1 is obtained through the above steps.

A series of steps from weighing of the raw materials to washing and collection of the nanoparticles 2 is performed in the inert gas atmosphere such as Ar atmosphere.

### (Method for Manufacturing Metal Magnetic Powder 1 by Liquid Phase Thermal Decomposition Accompanied by Disproportionation Reaction)

The disproportionation reaction means a reaction in which two or more molecules of one type of substance react with each other to produce two or more types of other substances. In a case where the metal magnetic powder 1 is manufactured by the liquid phase thermal decomposition accompanied by the disproportionation reaction, chlorotris(triphenylphosphine)cobalt (CoCl(Ph₃P)₃) is preferably used as a precursor (Co raw material). In the liquid phase thermal decomposition accompanied by the disproportionation reaction, two types of compounds of Co(0)(Ph₃P)₄ and Co(II)Cl₂(Ph₃P)₂ are produced from the precursor, and Co(0)(Ph₃P)₄ out of these compounds is decomposed to produce the nanoparticles 2 of Co. In this manufacturing method as well, it is preferable to add the raw material of the amphoteric metal such as ZnCl₂ as in the vapor phase thermal decomposition.

In the case where the metal magnetic powder 1 is manufactured by the liquid phase thermal decomposition accompanied by the disproportionation reaction, first, the precursor and the raw material of the amphoteric metal are weighed such that the metal magnetic powder 1 has a desired composition. Then, the precursor, the raw material of the amphoteric metal, and a solvent are put into a reaction vessel such as a separable flask, and these raw materials are stirred using a mechanical stirrer or the like. The content ratio of the amphoteric metal (W_{AM}/(W_{AM}+W_{Co})) in the metal magnetic powder 1 can be controlled by compounding ratios of the raw materials. As the solvent, ethanol, tetrahydrofuran (THF), or oleylamine is preferably used. In addition, a surfactant such as oleic acid may be added.

An atmosphere at the time of synthesizing the nanoparticles 2 is preferably an inert gas atmosphere such as Ar atmosphere or N₂ atmosphere. In a case where ethanol is used as the solvent, a temperature of a reaction solution during stirring (that is, a reaction temperature) is preferably 25° C. (room temperature) or higher and 65° C. or lower. On the other hand, in a case where THF or oleylamine is used as the solvent, the reaction temperature can be set to 10° C. or higher and 65° C. or lower, and is preferably 25° C. (room temperature) or higher and 40° C. or lower. As the reaction temperature is raised, the mean particle size of the nanoparticles 2 tends to increase.

In addition, a stirring time (that is, a reaction time) is desirably adjusted appropriately according to the reaction temperature, and is, for example, preferably 0.01 h to 80 h, and more preferably 0.1 h to 72 h when the reaction temperature is the room temperature. As the reaction time is increased, the mean particle size of the nanoparticles 2 tends to increase.

When the metal magnetic powder 1 is manufactured by the liquid phase thermal decomposition accompanied by the disproportionation reaction, a crystal structure of the nanoparticles 2 can be controlled by a type of the solvent, the reaction temperature, and the like. For example, the content ratio of hcp-Co (W_{hcp}/(W_{hcp}+W_{fcc}+W₂₄₉ )) tends to increase as the reaction temperature is lowered, and the sub-phase (fcc-Co and/or ε-Co) is more likely to be produced as the reaction temperature is raised. In the case where ethanol is used as the solvent, the content ratio of hcp-Co is likely to be higher as compared with a case where another solvent (THF or oleylamine) is used, and fcc-Co is more likely to be produced as the sub-phase at the reaction temperature of 25° C. or higher. In a case where THF is used as the solvent, a mixed-phase structure including hcp-Co as the main phase and fcc-Co as the sub-phase is likely to be obtained. In a case where oleylamine is used as the solvent, a mixed-phase structure including three phases of hcp-Co as the main phase and fcc-Co and ε-Co as the sub-phases tends to be obtained. In a case where the reaction temperature is set to exceed 40° C. while using oleylamine, a mixed-phase structure including hcp-Co as the main phase and ε-Co as the sub-phase is likely to be obtained.

In the liquid phase thermal decomposition accompanied by the disproportionation reaction as well, the raw material of the amphoteric metal may be added at the start of the reaction, or may be added after a lapse of a predetermined time from the start of the reaction. The existing locations of the amphoteric metal can be controlled by a timing of adding the raw material of the amphoteric metal. Specifically, when the raw material of the amphoteric metal is added at the start of the reaction, the amphoteric metal is likely to be present inside the nanoparticles 2. On the other hand, when the raw material of the amphoteric metal is added in the middle of the thermal decomposition reaction, the amphoteric metal adheres to the surfaces of the nanoparticles 2, and a proportion of the amphoteric metal present on the surfaces of the nanoparticles 2 tends to increase as the timing of adding the raw material of the amphoteric metal is delayed. Specifically, when the raw material of the amphoteric metal is added after a lapse of 3/4 RT or more from the start of the reaction assuming a final reaction time as RT, the amphoteric metal tends to be present on the surfaces of the nanoparticles 2 rather than inside the particles.

After the reaction is stopped by stopping the stirring of the reaction solution, the produced nanoparticles 2 are washed and collected. When the nanoparticles 2 are washed, a washing solvent in which an unreacted raw material, an intermediate product, and the like are soluble is used. For example, as the washing solvent, for example, an organic solvent such as acetone, dichlorobenzene, or ethanol can be used. It is preferable to subject the washing solvent to a degassing treatment in order to suppress oxidation of the nanoparticles 2. Alternatively, it is preferable to use a super-dehydrated-grade organic solvent having a moisture amount of 10 ppm or less as the washing solvent. Note that a magnet may be used to collect the nanoparticles 2. The metal magnetic powder 1 is obtained through the above steps.

A series of steps from weighing of the raw materials to washing and collection of the nanoparticles 2 is performed in the inert gas atmosphere such as Ar atmosphere.

### (Method for Manufacturing Composite Magnetic Body 10)

Next, an example of the method for manufacturing the composite magnetic body 10 is described.

The composite magnetic body 10 can be manufactured by mixing the metal magnetic powder 1, the resin 6, and a solvent and performing a predetermined dispersion treatment. As the dispersion treatment, it is preferable to adopt an ultrasonic dispersion treatment or a media dispersion treatment such as a beads mill. Conditions for the dispersion treatment are not particularly limited, and various conditions may be set such that the nanoparticles 2 are uniformly dispersed in the resin 6. As the solvent to be added in the dispersion treatment, for example, an organic solvent such as acetone, dichlorobenzene, or ethanol can be used, and it is preferable to use a degassed organic solvent or a super-dehydrated-grade organic solvent. In addition, various ceramic beads can be used as a medium used in the media dispersion treatment, and it is preferable to use beads of ZrO₂ having a large specific gravity among the ceramic beads.

Note that the existing locations of the amphoteric metal in the composite magnetic body 10 may be changed by the dispersion treatment. For example, the amphoteric metal adhering to the surfaces of the nanoparticles 2 is hardly peeled off when an ultrasonic dispersion treatment is performed, but the amphoteric metal adhering to the surfaces of the nanoparticles 2 is likely to be peeled off when the media dispersion treatment is performed. Therefore, a proportion of the amphoteric metal dispersed in the resin 6 tends to increase as a treatment time of the media dispersion is increased.

Slurry obtained by the above-described dispersion treatment is dried in the inert atmosphere such as Ar atmosphere to obtain a dried material in which the solvent has been volatilized. Thereafter, the dried material is subjected to griding using a mortar, a dry grinder, or the like to obtain granules containing the metal magnetic powder 1 and the resin 6. Then, the granules were charged into a press mold and pressed to obtain the composite magnetic body 10. In a case where a thermosetting resin is used as the resin 6, it is preferable to subject the composite magnetic body after pressure-mold to a curing treatment. The method for manufacturing the composite magnetic body 10 is not limited to the above-described pressure-mold method. For example, the slurry obtained by the dispersion treatment may be applied onto a PET film and dried to obtain sheet-like composite magnetic body 10.

A series of steps for obtaining the composite magnetic body 10 is also performed in the inert atmosphere, such as Ar atmosphere, similarly to the manufacturing of the metal magnetic powder 1.

### (Summary of Embodiment)

The metal magnetic powder 1 of the present embodiment includes the nanoparticles 2 having hcp-Co as the main phase and having the mean particle size (D50) of 1 nm to 100 nm (preferably 1 nm to 70 nm). Further, the metal magnetic powder 1 includes fcc-Co or/and ε-Co as the sub-phase. Since the metal magnetic powder 1 includes the nanoparticles 2 having a mixed-phase structure, it is possible to reduce the magnetic loss as compared with the related art while ensuring the high permeability in the high frequency band of 1 GHz or higher. In addition, the composite magnetic body 10 also includes the metal magnetic powder 1 having the above characteristics, and thus, it is possible to suitably achieve both the high permeability and the low magnetic loss in the high frequency band.

In the metal magnetic powder 1 and the composite magnetic body 10, W_{hcp}/(W_{hcp}+W_{fcc}+W_{ε}) is 70% or more and 99% or less. When the content ratio of hcp-Co as the main phase satisfies the above requirement, it is possible to more suitably achieve both the high permeability and the low magnetic loss in the high frequency band.

In addition, the metal magnetic powder 1 and the composite magnetic body 10 include amphoteric metal crystals (preferably Zn crystals). When the amphoteric metal is added to the metal magnetic powder 1 including the nanoparticles 2 having the mixed-phase structure of Co, the magnetic loss can be further reduced.

Both the metal magnetic powder 1 and the composite magnetic body 10 can be applied to various electronic components such as an inductor, a transformer, a choke coil, a filter, and an antenna, and particularly, can be suitably applied to an electronic component for a high-frequency circuit having an operation frequency of 1 GHz or higher (more preferably 1 GHz to 10 GHz).

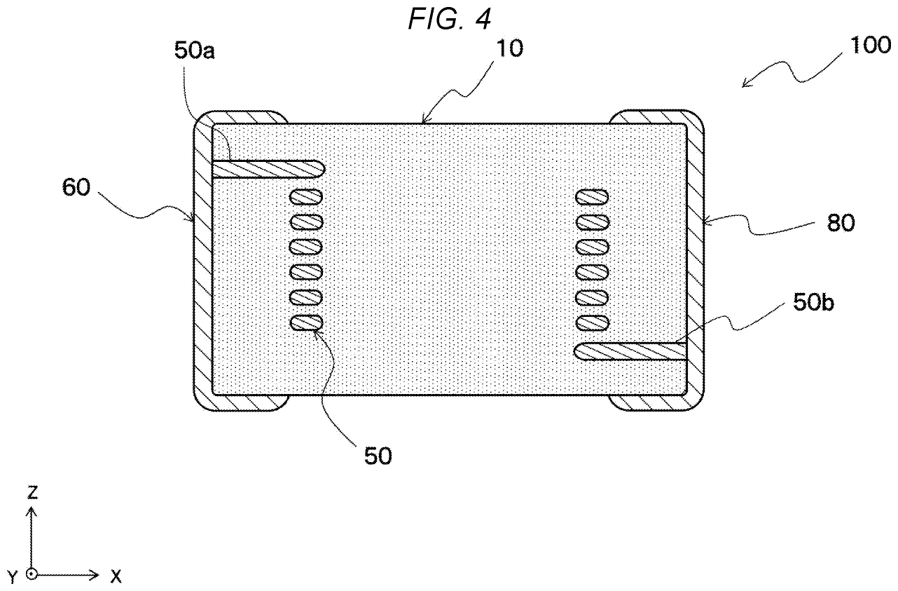

Examples of the electronic component containing the metal magnetic powder 1 (or the composite magnetic body 10) include an inductor 100 as shown in FIG. 4. The inductor 100 has an element body configured using the composite magnetic body 10 of the present embodiment, and a coil portion 50 is embedded in the element body. A pair of external electrodes 60 and 80 is formed on an end surface of the element body, and the external electrodes 60 and 80 are electrically connected to leadout portions 50a and 50b of the coil portion 50, respectively. The electronic component such as the inductor 100 contains the metal magnetic powder 1 (composite magnetic body 10) of the present embodiment, and thus, has excellent high-frequency properties.

Hereinabove, an embodiment of the present disclosure is described, but the present disclosure is not limited to the above-described embodiment, and various modifications can be made within a scope not departing from the gist of the present disclosure.

### EXAMPLES

Hereinafter, the present disclosure is described in further detail based on specific examples, but is not limited to the following examples.

### Experiment 1

In Experiment 1, metal magnetic powders according to Samples A1 to A18 were manufactured by the vapor phase thermal decomposition method. Specifically, Co₂(CO)₈ as a precursor was put into a separable flask, and the precursor was stirred using a mechanical stirrer while being heated to 57° C. An oil bath was used for heating the separable flask, but the precursor was thermally decomposed in the vapor phase without adding a solvent to the inside of the separable flask. The atmosphere at this time was Ar atmosphere, and a reaction time in each sample was set to a value shown in Table 1.

In Samples A1 to A6, the precursor was thermally decomposed without adding a surfactant. In Samples A7 to A12, oleic acid was added as a surfactant during thermal decomposition. In Samples A13 to A18, N-phenyl-3-aminopropyltrimethoxysilane as a silane coupling agent was added as a surfactant during thermal decomposition.

After nanoparticles were synthesized by the thermal decomposition, the separable flask was allowed to stand at a room temperature, and the produced nanoparticles were naturally cooled to the room temperature. After the cooling, the nanoparticles were washed using super dehydrated acetone and collected by magnet. Note that a series of steps from weighing of raw materials to the washing and collection were performed under the Ar atmosphere. The metal magnetic powders according to Samples A1 to A18 were obtained through the above steps.

Next, a composite magnetic body was manufactured using the metal magnetic powder. The method for manufacturing the composite magnetic body was similar for Samples A1 to A18.

First, the metal magnetic powder was weighed such that a content ratio of nanoparticles in the composite magnetic body was 10 vol %. Then, the weighed metal magnetic powder, an epoxy resin, and acetone as a solvent were mixed together, and the mixture was subjected to an ultrasonic dispersion treatment. A treatment time of the ultrasonic dispersion was set to 10 min, and a dispersion liquid obtained by the ultrasonic dispersion treatment was dried in Ar atmosphere at 50° C. to obtain a dried material. Then, the dried material was ground in a mortar, and then, the obtained granules were charged into a press mold and pressed to obtain the composite magnetic body. The composite magnetic body in each Sample had a toroidal shape having an outer diameter of 7 mm, an inner diameter of 3 mm, and a thickness of 1 mm. A series of steps for manufacturing the composite magnetic body was performed under the Ar atmosphere.

The following evaluations were performed for each of the Samples in Experiment 1.

### Mean Particle Size of Nanoparticles

The nanoparticles manufactured in each of the Samples of Experiment 1 were observed with a TEM (JEM-2100 F manufactured by JEOL Ltd.) at a magnification of 500,000 times. Then, equivalent circular diameters of 500 nanoparticles were measured using image analysis software to calculate a mean particle size (D50) thereof.

### Analysis of Crystal Structure

First, at the time of TEM observation, 50 nanoparticles isolated in the field of view were irradiated with an electron beam to obtain electron diffraction patterns. Then, whether each of the nanoparticles has a single-phase structure or a mixed-phase structure was identified on the basis of the obtained electron diffraction pattern. It has been confirmed that the nanoparticles had the mixed-phase structure in all of Samples A1 to A18 in Experiment 1.

In addition, an XRD pattern of the composite magnetic body was obtained by 2θ/θ measurement using an XRD device (Smart Lab manufactured by Rigaku Corporation). Then, the obtained XRD pattern was analyzed by X-ray analysis integrated software (SmartLab Studio II) to calculate content ratios of hcp-Co, fcc-Co, and ε-Co (W_{hcp}, W_{fcc}, and W_{ε}). In this analysis, the content ratio of each Co crystalline phase was calculated with a total of hcp-Co, fcc-Co, and ε-Co as 100%.

### Evaluation of Magnetic Properties

A real part (that is, a permeability μ′ (no unit)) and an imaginary part μ″ of a complex permeability at 5 GHz were measured by a coaxial S-parameter method using a network analyzer (HP8753D manufactured by Agilent Technologies, Inc.). Then, a magnetic loss tanδ (no unit) at 5 GHz was calculated as μ″/μ′. The permeability μ′ and the magnetic loss tanδ also vary depending on the content ratio of nanoparticles in the composite magnetic body. When the content ratio of nanoparticles in the composite magnetic body was 10 vol % as in each sample of Experiment 1, a sample having the permeability μ′ of 1.15 or more and the magnetic loss tanδ of 0.100 or less was determined as “good”.

Evaluation results of the Samples in Experiment 1 are shown in Table 1.

TABLE 1

| | | Powder manufacturing conditions | | | | | | | | |
|---|---|---|---|---|---|---|---|---|---|---|
| | | Reaction | | | Analysis result of metal magnetic powder | | | | Magnetic properties | |
| | | (° C.) | Reaction | Additive | D50 | Ratio of Co crystalline phase (%) | | | μ′ | tanδ |
| Sample No. | | temperature | time (h) | (surfactant) | (nm) | hcp-Co | fcc-Co | ε-Co | at 5 GHz | at 5 GHz |
| A1 | Ex. | 57 | 1 | — | 1 | 99 | 1 | 0 | 1.15 | 0.071 |
| A2 | Ex. | 57 | 3 | — | 19 | 97 | 3 | 0 | 1.17 | 0.072 |
| A3 | Ex. | 57 | 12 | — | 49 | 97 | 3 | 0 | 1.17 | 0.073 |
| A4 | Ex. | 57 | 24 | — | 70 | 98 | 2 | 0 | 1.18 | 0.075 |
| A5 | Ex. | 57 | 96 | — | 100 | 99 | 1 | 0 | 1.19 | 0.097 |
| A6 | Comp. Ex. | 57 | 120 | — | 110 | 98 | 2 | 0 | 1.13 | 0.120 |
| A7 | Ex. | 57 | 1 | Oleic acid | 1 | 95 | 0 | 5 | 1.16 | 0.074 |
| A8 | Ex. | 57 | 3 | Oleic acid | 19 | 94 | 0 | 6 | 1.17 | 0.075 |
| A9 | Ex. | 57 | 12 | Oleic acid | 52 | 95 | 0 | 5 | 1.18 | 0.077 |
| A10 | Ex. | 57 | 24 | Oleic acid | 70 | 93 | 0 | 7 | 1.19 | 0.080 |
| A11 | Ex. | 57 | 96 | Oleic acid | 100 | 93 | 0 | 7 | 1.20 | 0.092 |
| A12 | Comp. Ex. | 57 | 120 | Oleic acid | 110 | 93 | 0 | 7 | 1.12 | 0.125 |
| A13 | Ex. | 57 | 1 | Silane coupling agent | 1 | 93 | 4 | 3 | 1.17 | 0.075 |
| A14 | Ex. | 57 | 3 | Silane coupling agent | 22 | 94 | 3 | 3 | 1.18 | 0.077 |
| A15 | Ex. | 57 | 12 | Silane coupling agent | 49 | 93 | 4 | 3 | 1.18 | 0.079 |
| A16 | Ex. | 57 | 24 | Silane coupling agent | 70 | 93 | 4 | 3 | 1.21 | 0.081 |
| A17 | Ex. | 57 | 96 | Silane coupling agent | 100 | 95 | 3 | 2 | 1.22 | 0.091 |
| A18 | Comp. Ex. | 57 | 120 | Silane coupling agent | 110 | 93 | 4 | 3 | 1.11 | 0.122 |

As shown in Table 1, when a reaction temperature (thermal decomposition temperature) was set to 57° C., nanoparticles having a mean particle size (D50) of 1 nm to 100 nm and the mixed-phase structure were obtained in the samples (Examples) in which the reaction time was within the range of 1 to 96 h. In Samples A6, A12, and A18 (Comparative Examples) in which the reaction time was 120 h, nanoparticles had the mixed-phase structure, but a mean particle size (D50) of the nanoparticles was larger than 100 nm. In Samples A6, A12, and A18 as Comparative Examples, both a permeability and a magnetic loss failed to satisfy evaluation criteria. On the other hand, in Examples (Samples A1 to A5, A7 to A11, A13 to A17) in which the mean particle size (D50) was in the range of 1 nm to 100 nm, permeability properties and magnetic loss properties were improved as compared with Comparative Examples, and good magnetic properties were obtained at 5 GHz.

In Examples shown in Table 1, the magnetic loss could be reduced as the mean particle size was decreased. That is, it has been found that the mean particle size is preferably 72 nm or less, and more preferably 52 nm or less in the nanoparticles having the mixed-phase structure with hcp-Co as the main phase.

In addition, it has been found that a crystal structure of Co nanoparticles was changed by addition of the surfactant from the evaluation results shown in Table 1. Specifically, it has been found that, when no surfactant is added (Samples A1 to A6), fcc-Co is produced as the sub-phase, and the content ratio of hcp-Co as the main phase is higher than that in the case where the surfactant is added. On the other hand, it has been found that ε-Co is produced as the sub-phase when oleic acid was added as the surfactant (Samples A7 to A12), and fcc-Co and ε-Co are produced as sub-phases when N-phenyl-3-aminopropyltrimethoxysilane is added as the surfactant (Samples A13 to A18).

### Experiment 2

In Experiment 2, metal magnetic powders were manufactured under conditions shown in Tables 2 to 4 by changing a reaction temperature during thermal decomposition. In each of Samples B1 to B28 (and A1 to A6 in Experiment 1) shown in Table 2, Co₂(CO)₈ as a precursor was thermally decomposed in a vapor phase without adding a surfactant to obtain the metal magnetic powder. On the other hand, the metal magnetic powder of Co was manufactured by adding oleic acid in each of Samples C1 to C28 shown in Table 3 (and A7 to A12 in Experiment 1), and the metal magnetic powder was manufactured by adding N-phenyl-3-aminopropyltrimethoxysilane as a silane coupling agent in D1 to D28 shown in Table 4 (and A13 to A18 in Experiment 1).

The metal magnetic powders and composite magnetic bodies according to the respective samples of Experiment 2 were manufactured in the similar manner as in Experiment 1 except for the reaction temperature and the reaction time. Evaluation results of the respective samples of Experiment 2 are shown in Tables 2 to 4.

TABLE 2

| | | Powder manufacturing conditions | | | | | | | | |
|---|---|---|---|---|---|---|---|---|---|---|
| | | Reaction | | | Analysis result of metal magnetic powder | | | | Magnetic properties | |
| | | temperature | Reaction | | D50 | Ratio of Co crystalline phase (%) | | | μ′ | tanδ |
| Sample No. | | (° C.) | time (h) | Additive | (nm) | hcp-Co | fcc-Co | ε-Co | at 5 GHz | at 5 GHz |
| B1 | Comp. Ex. | 52 | 1.5 | — | 1 | 100 | 0 | 0 | 1.07 | 0.068 |
| B2 | Comp. Ex. | 52 | 4 | — | 18 | 100 | 0 | 0 | 1.12 | 0.063 |
| B3 | Comp. Ex. | 52 | 15 | — | 50 | 100 | 0 | 0 | 1.09 | 0.069 |
| B4 | Comp. Ex. | 52 | 30 | — | 70 | 100 | 0 | 0 | 1.10 | 0.071 |
| B5 | Comp. Ex. | 52 | 105 | — | 100 | 100 | 0 | 0 | 1.13 | 0.073 |
| B6 | Comp. Ex. | 52 | 135 | — | 110 | 100 | 0 | 0 | 1.11 | 0.095 |
| A1 | Ex. | 57 | 1 | — | 1 | 99 | 1 | 0 | 1.15 | 0.071 |
| A2 | Ex. | 57 | 3 | — | 19 | 97 | 3 | 0 | 1.17 | 0.072 |
| A3 | Ex. | 57 | 12 | — | 49 | 97 | 3 | 0 | 1.17 | 0.073 |
| A4 | Ex. | 57 | 24 | — | 70 | 98 | 2 | 0 | 1.18 | 0.075 |
| A5 | Ex. | 57 | 96 | — | 100 | 99 | 1 | 0 | 1.19 | 0.097 |
| A6 | Comp. Ex. | 57 | 120 | — | 110 | 98 | 2 | 0 | 1.13 | 0.120 |
| B7 | Ex. | 65 | 0.5 | — | 2 | 89 | 11 | 0 | 1.16 | 0.074 |
| B8 | Ex. | 65 | 2.5 | — | 20 | 92 | 8 | 0 | 1.17 | 0.073 |
| B9 | Ex. | 65 | 10 | — | 48 | 92 | 8 | 0 | 1.18 | 0.073 |
| B10 | Ex. | 65 | 22 | — | 71 | 88 | 12 | 0 | 1.20 | 0.076 |
| B11 | Ex. | 65 | 60 | — | 99 | 90 | 10 | 0 | 1.20 | 0.096 |
| B12 | Ex. | 80 | 0.25 | — | 1 | 84 | 16 | 0 | 1.17 | 0.077 |
| B13 | Ex. | 80 | 2.2 | — | 22 | 87 | 13 | 0 | 1.19 | 0.075 |
| B14 | Ex. | 80 | 7 | — | 51 | 86 | 14 | 0 | 1.19 | 0.074 |
| B15 | Ex. | 80 | 15 | — | 69 | 83 | 17 | 0 | 1.22 | 0.077 |
| B16 | Ex. | 80 | 50 | — | 99 | 86 | 14 | 0 | 1.21 | 0.098 |
| B17 | Ex. | 120 | 0.1 | — | 3 | 70 | 30 | 0 | 1.18 | 0.079 |
| B18 | Ex. | 120 | 1.8 | — | 18 | 70 | 30 | 0 | 1.21 | 0.078 |
| B19 | Ex. | 120 | 5 | — | 51 | 72 | 28 | 0 | 1.20 | 0.077 |
| B20 | Ex. | 120 | 8 | — | 66 | 71 | 29 | 0 | 1.24 | 0.079 |
| B21 | Ex. | 150 | 0.05 | — | 1 | 55 | 45 | 0 | 1.20 | 0.084 |
| B22 | Ex. | 150 | 1.5 | — | 19 | 57 | 43 | 0 | 1.24 | 0.085 |
| B23 | Ex. | 150 | 2.5 | — | 52 | 53 | 47 | 0 | 1.24 | 0.086 |
| B24 | Ex. | 150 | 3.5 | — | 71 | 53 | 47 | 0 | 1.28 | 0.088 |
| B25 | Ex. | 180 | 0.01 | — | 3 | 50 | 50 | 0 | 1.23 | 0.085 |
| B26 | Ex. | 180 | 1 | — | 18 | 50 | 50 | 0 | 1.25 | 0.085 |
| B27 | Ex. | 180 | 2 | — | 52 | 50 | 50 | 0 | 1.26 | 0.085 |
| B28 | Ex. | 180 | 3 | — | 71 | 51 | 49 | 0 | 1.28 | 0.088 |

TABLE 3

| | | Powder manufacturing conditions | | | | | | | | |
|---|---|---|---|---|---|---|---|---|---|---|
| | | Reaction | | | Analysis result of metal magnetic powder | | | | Magnetic properties | |
| | | temperature | Reaction | | D50 | Ratio of Co crystalline phase (%) | | | μ′ | tanδ |
| Sample No. | | (° C.) | time (h) | Additive | (nm) | hcp-Co | fcc-Co | ε-Co | at 5 GHz | at 5 GHz |
| C1 | Ex. | 52 | 1.5 | Oleic acid | 1 | 98 | 0 | 2 | 1.16 | 0.073 |
| C2 | Ex. | 52 | 4 | Oleic acid | 22 | 98 | 0 | 2 | 1.18 | 0.075 |
| C3 | Ex. | 52 | 15 | Oleic acid | 52 | 97 | 0 | 3 | 1.19 | 0.074 |
| C4 | Ex. | 52 | 30 | Oleic acid | 69 | 96 | 0 | 4 | 1.20 | 0.077 |
| C5 | Ex. | 52 | 105 | Oleic acid | 99 | 96 | 0 | 4 | 1.21 | 0.090 |
| C6 | Comp. Ex. | 52 | 135 | Oleic acid | 108 | 96 | 0 | 4 | 1.12 | 0.125 |
| A7 | Ex. | 57 | 1 | Oleic acid | 1 | 95 | 0 | 5 | 1.16 | 0.074 |
| A8 | Ex. | 57 | 3 | Oleic acid | 19 | 94 | 0 | 6 | 1.17 | 0.075 |
| A9 | Ex. | 57 | 12 | Oleic acid | 52 | 95 | 0 | 5 | 1.18 | 0.077 |
| A10 | Ex. | 57 | 24 | Oleic acid | 70 | 93 | 0 | 7 | 1.19 | 0.080 |
| A11 | Ex. | 57 | 96 | Oleic acid | 100 | 93 | 0 | 7 | 1.20 | 0.092 |
| A12 | Comp. Ex. | 57 | 120 | Oleic acid | 110 | 93 | 0 | 7 | 1.12 | 0.125 |
| C7 | Ex. | 65 | 0.5 | Oleic acid | 3 | 89 | 0 | 11 | 1.17 | 0.074 |
| C8 | Ex. | 65 | 2.5 | Oleic acid | 21 | 89 | 0 | 11 | 1.18 | 0.077 |
| C9 | Ex. | 65 | 10 | Oleic acid | 49 | 88 | 0 | 12 | 1.20 | 0.079 |
| C10 | Ex. | 65 | 22 | Oleic acid | 68 | 92 | 0 | 8 | 1.20 | 0.080 |
| C11 | Ex. | 65 | 60 | Oleic acid | 100 | 92 | 0 | 8 | 1.22 | 0.092 |
| C12 | Ex. | 80 | 0.25 | Oleic acid | 3 | 69 | 0 | 31 | 1.18 | 0.074 |
| C13 | Ex. | 80 | 2.2 | Oleic acid | 19 | 70 | 0 | 30 | 1.20 | 0.078 |
| C14 | Ex. | 80 | 7 | Oleic acid | 49 | 69 | 0 | 31 | 1.21 | 0.081 |
| C15 | Ex. | 80 | 15 | Oleic acid | 70 | 72 | 0 | 28 | 1.22 | 0.081 |
| C16 | Ex. | 80 | 50 | Oleic acid | 100 | 69 | 0 | 31 | 1.24 | 0.099 |
| C17 | Ex. | 120 | 0.1 | Oleic acid | 2 | 62 | 0 | 38 | 1.21 | 0.078 |
| C18 | Ex. | 120 | 1.8 | Oleic acid | 18 | 60 | 0 | 40 | 1.23 | 0.083 |
| C19 | Ex. | 120 | 5 | Oleic acid | 48 | 62 | 0 | 38 | 1.23 | 0.083 |
| C20 | Ex. | 120 | 8 | Oleic acid | 70 | 58 | 0 | 42 | 1.24 | 0.084 |
| C21 | Ex. | 150 | 0.05 | Oleic acid | 1 | 50 | 0 | 50 | 1.23 | 0.081 |
| C22 | Ex. | 150 | 1.5 | Oleic acid | 21 | 51 | 0 | 49 | 1.24 | 0.082 |
| C23 | Ex. | 150 | 2.5 | Oleic acid | 50 | 50 | 0 | 50 | 1.24 | 0.084 |
| C24 | Ex. | 150 | 3.5 | Oleic acid | 70 | 51 | 0 | 49 | 1.25 | 0.085 |
| C25 | Comp. Ex. | 180 | 0.01 | Oleic acid | 3 | 42 | 0 | 58 | 1.29 | 0.103 |
| C26 | Comp. Ex. | 180 | 1 | Oleic acid | 21 | 41 | 0 | 59 | 1.28 | 0.104 |
| C27 | Comp. Ex. | 180 | 2 | Oleic acid | 51 | 38 | 0 | 62 | 1.33 | 0.105 |
| C28 | Comp. Ex. | 180 | 3 | Oleic acid | 68 | 42 | 0 | 58 | 1.32 | 0.104 |

TABLE 4

| | | Powder manufacturing conditions | | | | | | | | |
|---|---|---|---|---|---|---|---|---|---|---|
| | | Reaction | | | Analysis result of metal magnetic powder | | | | Magnetic properties | |
| | | temperature | Reaction | | D50 | Ratio of Co crystalline phase (%) | | | μ′ | tanδ |
| Sample No. | | (° C.) | time (h) | Additive | (nm) | hcp-Co | fcc-Co | ε-Co | at 5 GHz | at 5 GHz |
| D1 | Ex. | 52 | 1.5 | Silane coupling agent | 3 | 98 | 1 | 1 | 1.16 | 0.073 |
| D2 | Ex. | 52 | 4 | Silane coupling agent | 20 | 96 | 2 | 2 | 1.17 | 0.076 |
| D3 | Ex. | 52 | 15 | Silane coupling agent | 49 | 98 | 1 | 1 | 1.18 | 0.078 |
| D4 | Ex. | 52 | 30 | Silane coupling agent | 69 | 96 | 2 | 2 | 1.20 | 0.084 |
| D5 | Ex. | 52 | 105 | Silane coupling agent | 98 | 98 | 1 | 1 | 1.23 | 0.092 |
| D6 | Comp. Ex. | 52 | 135 | Silane coupling agent | 112 | 96 | 2 | 2 | 1.12 | 0.124 |
| A13 | Ex. | 57 | 1 | Silane coupling agent | 1 | 93 | 4 | 3 | 1.17 | 0.075 |
| A14 | Ex. | 57 | 3 | Silane coupling agent | 22 | 94 | 3 | 3 | 1.18 | 0.077 |
| A15 | Ex. | 57 | 12 | Silane coupling agent | 49 | 93 | 4 | 3 | 1.18 | 0.079 |
| A16 | Ex. | 57 | 24 | Silane coupling agent | 70 | 93 | 4 | 3 | 1.21 | 0.081 |
| A17 | Ex. | 57 | 96 | Silane coupling agent | 100 | 95 | 3 | 2 | 1.22 | 0.091 |
| A18 | Comp. Ex. | 57 | 120 | Silane coupling agent | 110 | 93 | 4 | 3 | 1.11 | 0.122 |
| D7 | Ex. | 65 | 0.5 | Silane coupling agent | 3 | 91 | 5 | 4 | 1.18 | 0.075 |
| D8 | Ex. | 65 | 2.5 | Silane coupling agent | 19 | 92 | 5 | 3 | 1.20 | 0.079 |
| D9 | Ex. | 65 | 10 | Silane coupling agent | 51 | 92 | 5 | 3 | 1.20 | 0.080 |
| D10 | Ex. | 65 | 22 | Silane coupling agent | 69 | 92 | 5 | 3 | 1.22 | 0.082 |
| D11 | Ex. | 65 | 60 | Silane coupling agent | 99 | 91 | 5 | 4 | 1.24 | 0.093 |
| D12 | Ex. | 80 | 0.25 | Silane coupling agent | 2 | 71 | 18 | 11 | 1.20 | 0.077 |
| D13 | Ex. | 80 | 2.2 | Silane coupling agent | 20 | 68 | 20 | 12 | 1.22 | 0.079 |
| D14 | Ex. | 80 | 7 | Silane coupling agent | 48 | 69 | 19 | 12 | 1.21 | 0.081 |
| D15 | Ex. | 80 | 5 | Silane coupling agent | 70 | 69 | 19 | 12 | 1.23 | 0.085 |
| D16 | Ex. | 80 | 50 | Silane coupling agent | 100 | 72 | 18 | 10 | 1.26 | 0.095 |
| D17 | Ex. | 120 | 0.1 | Silane coupling agent | 3 | 59 | 27 | 14 | 1.22 | 0.080 |
| D18 | Ex. | 120 | 1.8 | Silane coupling agent | 18 | 58 | 27 | 15 | 1.23 | 0.082 |
| D19 | Ex. | 120 | 5 | Silane coupling agent | 52 | 59 | 27 | 14 | 1.22 | 0.084 |
| D20 | Ex. | 120 | 8 | Silane coupling agent | 67 | 60 | 26 | 14 | 1.25 | 0.087 |
| D21 | Ex. | 150 | 0.05 | Silane coupling agent | 2 | 50 | 33 | 17 | 1.23 | 0.083 |
| D22 | Ex. | 150 | 1.5 | Silane coupling agent | 21 | 51 | 32 | 17 | 1.24 | 0.082 |
| D23 | Ex. | 150 | 2.5 | Silane coupling agent | 51 | 51 | 33 | 16 | 1.23 | 0.084 |
| D24 | Ex. | 150 | 3.5 | Silane coupling agent | 69 | 52 | 32 | 16 | 1.26 | 0.088 |
| D25 | Comp. Ex. | 180 | 0.01 | Silane coupling agent | 2 | 40 | 40 | 20 | 1.30 | 0.102 |
| D26 | Comp. Ex. | 180 | 1 | Silane coupling agent | 22 | 39 | 41 | 20 | 1.31 | 0.102 |
| D27 | Comp. Ex. | 180 | 2 | Silane coupling agent | 50 | 42 | 39 | 19 | 1.33 | 0.103 |
| D28 | Comp. Ex. | 180 | 3 | Silane coupling agent | 68 | 38 | 41 | 21 | 1.33 | 0.103 |

From the evaluation results in Tables 2 to 4, it has been found that a sub-phase is more likely to be produced, and the content ratio of hcp-Co decreases as the reaction temperature at the time of vapor phase thermal decomposition is raised. In other words, it has been found that the content ratio of hcp-Co increases as the reaction temperature at the time of vapor phase thermal decomposition is lowered.

In Samples B1 to B6 (Comparative Examples) shown in Table 2, a precursor was thermally decomposed at 52° C. without adding the surfactant to obtain a metal magnetic powder having no sub-phase. In Samples B1 to B6, a magnetic loss was 0.100 or less, but a permeability was lower than 1.15 (reference value), and the evaluation criteria for magnetic properties were not satisfied. Under the condition that no surfactant was used, the mixed-phase structure containing the main phase of hcp-Co (crystalline phase occupying 50% or more of nanoparticles) and the sub-phase of fcc-Co was obtained when the reaction temperature was set to 57° C. to 180° C. In Examples (Samples A1 to A5 and Samples B7 to B28) in which a mean particle size (D50) was in the range of 1 nm to 100 nm among samples containing nanoparticles having the mixed-phase structures, both a high permeability and a low magnetic loss could be obtained at 5 GHz.

In Samples C25 to C28 (Comparative Examples) shown in Table 3, oleic acid was added, and the precursor was thermally decomposed at a high temperature of 180° C. to obtain a metal magnetic powder having ε-Co as the main phase. In Samples C25 to C28 having ε-Co as the main phase, a high permeability was obtained at 5 GHz, but a magnetic loss was higher than 0.100, and the evaluation criteria of magnetic properties were not satisfied. When oleic acid was added, a mixed-phase structure containing a main phase of hcp-Co and a sub-phase of ε-Co was obtained by setting the reaction temperature to 52° C. to 150° C. In Examples (Samples C1 to C5, A7 to A11, and C7 to C24) in which a mean particle size (D50) was in the range of 1 nm to 100 nm among samples containing nanoparticles having the mixed-phase structures, both a high permeability and a low magnetic loss could be obtained at 5 GHz.

In Samples D25 to D28 shown in Table 4, N-phenyl-3-aminopropyltrimethoxysilane was added, and a precursor was thermally decomposed at a high temperature of 180° C. to obtain a metal magnetic powder in which a ratio of hcp-Co was less than 50%. In these Samples D25 to D28, a high permeability was obtained at 5 GHz, but a magnetic loss was higher than 0.100, and the evaluation criteria of magnetic properties were not satisfied. When N-phenyl-3-aminopropyltrimethoxysilane was added, a mixed-phase structure containing a main phase of hcp-Co and sub-phases of fcc-Co and ε-Co was obtained by setting the reaction temperature to 52° C. to 150° C. In Examples (Samples D1 to D5, A13 to A17, and D7 to D24) in which a mean particle size (D50) was in the range of 1 nm to 100 nm among samples containing nanoparticles having the mixed-phase structures, both a high permeability and a low magnetic loss could be obtained at 5 GHz.

From the results of Tables 2 to 4 described above, it has been found that both the high permeability and the low magnetic loss can be achieved in a high frequency band when the Co nanoparticles having the mean particle size (D50) in the range of 1 nm to 100 nm contain the main phase of hcp-Co and the sub-phase of fcc-Co or/and ε-Co. In Examples shown in Tables 2 to 4, the magnetic loss tends to be decreased as the ratio of hcp-Co as the main phase is higher, and the permeability tends to increase as the ratio of the sub-phase is higher. It has been found that the content ratio of hcp-Co (W_{hcp}/(W_{hcp}+W_{fcc}+W_{ε})) in the metal magnetic powder is preferably 68% or more and 99% or less, and more preferably 80% or more and 99% or less.

### Experiment 3

In Experiment 3, composite magnetic bodies according to Samples H1 to H8 corresponding to Comparative Examples were manufactured in order to evaluate the influence of a mixed-phase structure of Co nanoparticles on magnetic properties in more detail.

### Sample H1 (Comparative Example)

In Sample H1, a metal magnetic powder was manufactured by a liquid phase thermal decomposition method. First, Co₂(CO)₈ as a precursor and dichlorobenzene as a solvent were put into a separable flask to obtain a reaction solution. Then, the separable flask was placed in an oil bath, heated to 180° C., and the reaction solution was stirred with a mechanical stirrer. That is, Co nanoparticles were manufactured by thermally decomposing Co₂(CO)₈ in dichlorobenzene heated to 180° C.

After the reaction solution was stirred for 0.5 hours, the separable flask was allowed to stand at a room temperature, and produced nanoparticles were naturally cooled to the room temperature. After the cooling, the nanoparticles were washed using super dehydrated acetone and collected by magnet. The metal magnetic powder according to Sample H1 (Comparative Example) was obtained by the above steps. Note that a series of operations from weighing of raw materials to the washing and collection were performed under the Ar atmosphere.

When a crystal structure of nanoparticles has been confirmed by electron diffraction using TEM, it has been found that single-phase nanoparticles including ε-Co were obtained in Sample H1. In Sample H1, a composite magnetic body was manufactured using the metal magnetic powder under the same conditions as those in Experiment 1.

### Samples H2 to H4 (Comparative Examples)

In Samples H2 to H4, the metal magnetic powder of Sample B2 (Comparative Example) having the single-phase structure of hcp-Co (hereinafter referred to as B2 powder) and the metal magnetic powder of Sample H1 (Comparative Example) having the single-phase structure of ε-Co (hereinafter referred to as H1 powder) were mixed together to manufacture a composite magnetic body. Compounding ratios of the B2 powder and the H1 powder was controlled to make content ratios of the Co crystalline phases in the mixed powder have values shown in Table 5. Note that manufacturing conditions of the composite magnetic bodies in Samples H2 to H4 were the same as those in Experiment 1 except that the mixed powder was used.

### Sample H5 (Comparative Example)

In Sample H5, when a metal magnetic powder was manufactured by a liquid phase thermal decomposition method, Co2(CO)8 was used as a precursor, tetralin (1,2,3,4-tetrahydronaphthalene) was used as a solvent, (polyvinylpyrrolidone (Poly (N-vinyl-2 pyrrolidone))) was used as a surfactant, and a reaction temperature was set to 200° C. Manufacturing conditions other than the above were the same as those for Sample H1. When a crystal structure of nanoparticles has been confirmed by electron diffraction using TEM, it has been found that single-phase nanoparticles including fcc-Co were obtained in Sample H5. In Sample H5, a composite magnetic body was manufactured using the metal magnetic powder under the same conditions as those in Experiment 1.

### Samples H6 to H8 (Comparative Examples)

In Samples H6 to H8, the B2 powder having the single-phase structure of hcp-Co and the metal magnetic powder of Sample H5 having the single-phase structure of fcc-Co (hereinafter referred to as H5 powder) were mixed to manufacture a composite magnetic body. Compounding ratios of the B2 powder and the H5 powder was controlled to make content ratios of the Co crystalline phases in the mixed powder have values shown in Table 5. Note that manufacturing conditions of the composite magnetic bodies in Samples H6 to H8 were the same as those in Experiment 1 except that the mixed powder was used.

Evaluation results of Experiment 3 are shown in Table 5. Note that Table 5 also shows the evaluation results of Samples A2, B2, B13, and B22 in Experiments 1 and 2.

TABLE 5

| | | Manufacturing conditions | | | | | | | | | | |
|---|---|---|---|---|---|---|---|---|---|---|---|---|
| | | | Reaction | | | Analysis result of metal magnetic powder | | | | | Magnetic properties | |
| | | | temperature | Reaction | | D50 | Crystal | Ratio (%) | | | μ′ | tanδ |
| Sample No. | | Solvent | (° C.) | time (h) | Additive | (nm) | structure | hcp-Co | fcc-Co | ε-Co | at 5 GHz | at 5 GHz |
| A2 | Ex. | — | 57 | 3 | — | 19 | Mixed phase | 97 | 3 | 0 | 1.17 | 0.072 |
| B13 | Ex. | — | 80 | 2.2 | — | 22 | Mixed phase | 87 | 13 | 0 | 1.19 | 0.075 |
| B22 | Ex. | — | 150 | 1.5 | — | 19 | Mixed phase | 57 | 43 | 0 | 1.24 | 0.085 |
| B2 | Comp. Ex. | — | 52 | 4 | — | 18 | Single phase | 100 | 0 | 0 | 1.12 | 0.063 |
| H1 | Comp. Ex. | Dichloro- | 180 | 0.5 | — | 21 | Single phase | 0 | 0 | 100 | 1.32 | 0.250 |
| | | benzene | | | | | | | | | | |
| H2 | Comp. Ex. | B2 powder and H1 power were mixed | | | | 18 | Single phase | 96 | 0 | 4 | 1.13 | 0.072 |
| H3 | Comp. Ex. | | | | | 19 | Single phase | 69 | 0 | 31 | 1.18 | 0.122 |
| H4 | Comp. Ex. | | | | | 20 | Single phase | 50 | 0 | 50 | 1.22 | 0.158 |
| H5 | Comp. Ex. | 1,2,3,4- | 200 | 0.5 | PVP | 19 | Single phase | 0 | 100 | 0 | 1.33 | 0.249 |
| | | tetrahydro- | | | | | | | | | | |
| | | naphthalene | | | | | | | | | | |
| H6 | Comp. Ex. | B2 powder and H5 power were mixed | | | | 18 | Single phase | 96 | 4 | 0 | 1.14 | 0.070 |
| H7 | Comp. Ex. | | | | | 18 | Single phase | 70 | 30 | 0 | 1.18 | 0.118 |
| H8 | Comp. Ex. | | | | | 19 | Single phase | 50 | 50 | 0 | 1.23 | 0.155 |

As shown in Table 5, in the case of mixing the metal magnetic powders each having the single-phase structure, the magnetic loss was as low as 0.080 or less when a compounding ratio of the B2 powder having hcp-Co was increased, but the permeability was as low as less than 1.15, and the evaluation criterion for the permeability was not satisfied (Sample H2 and Sample H6). On the other hand, when the compounding ratio of the H1 powder having ε-Co or the H5 powder having fcc-Co was increased, the permeability was 1.15 or more but the magnetic loss exceeded 0.100, and the evaluation criteria for the magnetic loss was not satisfied (Samples H3, H4, H7, and H8). In this manner, it has failed to achieve both the high permeability and the low magnetic loss in the samples in which the metal magnetic powders each having the single-phase structure is mixed.

On the other hand, in Examples (Samples A2, B13, and B22) each having the mixed-phase structure, the permeability was 1.15 or more, and the magnetic loss was 0.100 or less. From the results of Experiment 1 to 3, it has been found that both the high permeability and the low magnetic loss can be suitably achieved in the high frequency band when the nanoparticles whose main phase is hcp-Co have the mixed-phase structure containing fcc-Co and/or ε-Co.

### Experiment 4

In Experiment 4, ZnCl₂ was added as a raw material of an amphoteric metal, and metal magnetic powders according to Samples E1 to E6 were manufactured by a vapor phase thermal decomposition method. ZnCl₂ was added at the start of reaction, and the amount of ZnCl₂ to be added was controlled to make a content ratio of Zn (W_{AM}/(W_{Co}+W_{AM})) in each sample have a value shown in Table 6. In Experiment 4, a reaction temperature was set to 57° C., and a reaction time was set to 3 h such that a mean particle size (D50) of nanoparticles was 20±2 nm. Manufacturing conditions other the above were the same as those in Experiment 1, and magnetic properties of composite magnetic bodies according to Samples E1 to E6 were evaluated. Evaluation results of Experiment 4 are shown in Table 6.

TABLE 6

| | | Powder manufacturing conditions | | | Analysis result of metal magnetic powder | | | | | | |
|---|---|---|---|---|---|---|---|---|---|---|---|
| | | Reaction | | | | | | | Content | Magnetic properties | |
| | | temperature | Reaction | | D50 | Ratio (%) | | | Ratio | μ′ | tanδ |
| Sample No. | | (° C.) | time (h) | Additive | (nm) | hcp-Co | fcc-Co | ε-Co | of Zn (%) | at 5 GHz | at 5 GHz |
| A2 | Ex. | 57 | 3 | — | 19 | 97 | 3 | 0 | 0 | 1.17 | 0.072 |
| E1 | Ex. | 57 | 3 | ZnCl₂ | 21 | 98 | 2 | 0 | 0.001 | 1.16 | 0.070 |
| E2 | Ex. | 57 | 3 | ZnCl₂ | 19 | 98 | 2 | 0 | 1 | 1.16 | 0.071 |
| E3 | Ex. | 57 | 3 | ZnCl₂ | 18 | 99 | 1 | 0 | 3 | 1.16 | 0.070 |
| E4 | Ex. | 57 | 3 | ZnCl₂ | 21 | 99 | 1 | 0 | 5 | 1.16 | 0.068 |
| E5 | Ex. | 57 | 3 | ZnCl₂ | 18 | 98 | 2 | 0 | 7 | 1.16 | 0.070 |
| E6 | Ex. | 57 | 3 | ZnCl₂ | 19 | 98 | 2 | 0 | 10 | 1.15 | 0.071 |

As shown in Table 6, in Samples E1 to E6 in which Zn was added as the amphoteric metal, both a high permeability and a low magnetic loss were achieved at 5 GHz. In XRD patterns of Samples E1 to E6, diffraction peaks of Zn were detected, and it has been confirmed that Zn is present as metal crystals.

### Experiment 5

In Experiment 5, a metal magnetic powder according to each Sample was manufactured under a condition shown in Table 7. Specifically, in Experiment 5, metal magnetic powders having different content ratios of Co crystalline phases were manufactured by adding ZnCl₂ at the start of the reaction and changing a reaction temperature. A reaction time was set to a predetermined time according to the reaction temperature such that a mean particle size (D50) of nanoparticles in each sample was 20±2 nm. Manufacturing conditions other the above were the same as those in Experiment 1, and magnetic properties of composite magnetic bodies according to the respective samples were measured. Evaluation results of Experiment 5 are shown in Table 7.

TABLE 7

| | | Powder manufacturing conditions | | | | Analysis result of metal magnetic powder | | | | | | |
|---|---|---|---|---|---|---|---|---|---|---|---|---|
| | | Reaction | | | | | | | | Content | Magnetic properties | |
| | | temperature | Reaction | Additive 1 | | D50 | Ratio (%) | | | Ratio | μ′ | tanδ |
| Sample No. | | (° C.) | time (h) | Surfactant | Additive 2 | (nm) | hcp-Co | fcc-Co | ε-Co | of Zn (%) | at 5 GHz | at 5 GHz |
| F1 | Comp. Ex. | 52 | 4 | — | ZnCl₂ | 21 | 100 | 0 | 0 | 7 | 1.08 | 0.061 |
| E5 | Ex. | 57 | 3 | — | ZnCl₂ | 18 | 98 | 2 | 0 | 7 | 1.16 | 0.070 |
| F2 | Ex. | 65 | 2.5 | — | ZnCl₂ | 22 | 91 | 9 | 0 | 7 | 1.15 | 0.072 |
| F3 | Ex. | 80 | 2.2 | — | ZnCl₂ | 20 | 86 | 14 | 0 | 7 | 1.16 | 0.073 |
| F4 | Ex. | 120 | 1.8 | — | ZnCl₂ | 19 | 71 | 29 | 0 | 7 | 1.16 | 0.075 |
| F5 | Ex. | 150 | 1.5 | — | ZnCl₂ | 22 | 56 | 44 | 0 | 7 | 1.20 | 0.076 |
| F6 | Ex. | 180 | 1 | — | ZnCl₂ | 21 | 51 | 49 | 0 | 7 | 1.21 | 0.079 |
| F7 | Ex. | 52 | 4 | Oleic acid | ZnCl₂ | 19 | 97 | 0 | 3 | 7 | 1.18 | 0.074 |
| F8 | Ex. | 57 | 3 | Oleic acid | ZnCl₂ | 18 | 93 | 0 | 7 | 7 | 1.17 | 0.075 |
| F9 | Ex. | 65 | 2.5 | Oleic acid | ZnCl₂ | 19 | 88 | 0 | 12 | 7 | 1.17 | 0.076 |
| F10 | Ex. | 80 | 2.2 | Oleic acid | ZnCl₂ | 18 | 69 | 0 | 31 | 7 | 1.18 | 0.075 |
| F11 | Ex. | 120 | 1.8 | Oleic acid | ZnCl₂ | 20 | 59 | 0 | 41 | 7 | 1.22 | 0.080 |
| F12 | Ex. | 150 | 1.5 | Oleic acid | ZnCl₂ | 20 | 51 | 0 | 49 | 7 | 1.23 | 0.079 |
| F13 | Comp. Ex. | 180 | 1 | Oleic acid | ZnCl₂ | 22 | 39 | 0 | 61 | 7 | 1.27 | 0.102 |
| F14 | Ex. | 52 | 4 | Silane | ZnCl₂ | 19 | 96 | 2 | 2 | 7 | 1.16 | 0.075 |
| | | | | coupling | | | | | | | | |
| | | | | agent | | | | | | | | |
| F15 | Ex. | 57 | 3 | Silane | ZnCl₂ | 21 | 93 | 4 | 3 | 7 | 1.17 | 0.076 |
| | | | | coupling | | | | | | | | |
| | | | | agent | | | | | | | | |
| F16 | Ex. | 65 | 2.5 | Silane | ZnCl₂ | 21 | 90 | 6 | 4 | 7 | 1.19 | 0.077 |
| | | | | coupling | | | | | | | | |
| | | | | agent | | | | | | | | |
| F17 | Ex. | 80 | 2.2 | Silane | ZnCl₂ | 20 | 67 | 20 | 13 | 7 | 1.20 | 0.078 |
| | | | | coupling | | | | | | | | |
| | | | | agent | | | | | | | | |
| F18 | Ex. | 120 | 1.8 | Silane | ZnCl₂ | 18 | 57 | 28 | 15 | 7 | 1.22 | 0.080 |
| | | | | coupling | | | | | | | | |
| | | | | agent | | | | | | | | |
| F19 | Ex. | 150 | 1.5 | Silane | ZnCl₂ | 18 | 50 | 33 | 17 | 7 | 1.23 | 0.080 |
| | | | | coupling | | | | | | | | |
| | | | | agent | | | | | | | | |
| F20 | Comp. Ex. | 180 | 1 | Silane | ZnCl₂ | 20 | 38 | 39 | 23 | 7 | 1.29 | 0.102 |
| | | | | coupling | | | | | | | | |
| | | | | agent | | | | | | | | |

Although the magnetic loss tended to increase as the content ratio of the sub-phase increased in Experiment 2 in which Zn was not added, the magnetic loss tended to be reduced in Examples of Experiment 5 shown in Table 7 due to the addition of Zn as compared with Experiment 2 (Tables 2 to 4). From this result, it has been found that the magnetic loss in the high frequency band can be further reduced by adding the amphoteric metal. In addition, it has been also confirmed by XRD analysis that Zn is present as metal crystals in each of Examples of Experiment 5.

### Experiment 6

In Experiment 6, a metal magnetic powder according to each sample was manufactured under a condition shown in Table 8. Specifically, in Experiment 6, metal magnetic powders having different mean particle sizes were manufactured by adding ZnCl₂ at the start of the reaction and changing a reaction time. A reaction temperature in each sample was set to 57° C. Manufacturing conditions other the above were the same as those in Experiment 1, and magnetic properties of composite magnetic bodies according to the respective samples were measured. Evaluation results of Experiment 6 are shown in Table 8.

TABLE 8

| | | Powder manufacturing conditions | | | | Analysis result of metal magnetic powder | | | | | | |
|---|---|---|---|---|---|---|---|---|---|---|---|---|
| | | Reaction | | | | | | | | Content | Magnetic properties | |
| | | temperature | Reaction | Additive 1 | | D50 | Ratio (%) | | | Ratio | μ′ | tanδ |
| Sample No. | | (° C.) | time (h) | Surfactant | Additive 2 | (nm) | hcp-Co | fcc-Co | ε-Co | of Zn (%) | at 5 GHz | at 5 GHz |
| G1 | Ex. | 57 | 1 | — | ZnCl₂ | 1 | 99 | 1 | 0 | 7 | 1.15 | 0.070 |
| E5 | Ex. | 57 | 3 | — | ZnCl₂ | 18 | 98 | 2 | 0 | 7 | 1.16 | 0.070 |
| G2 | Ex. | 57 | 12 | — | ZnCl₂ | 48 | 98 | 2 | 0 | 7 | 1.16 | 0.071 |
| G3 | Ex. | 57 | 24 | — | ZnCl₂ | 71 | 98 | 2 | 0 | 7 | 1.17 | 0.073 |
| G4 | Ex. | 57 | 96 | — | ZnCl₂ | 99 | 97 | 3 | 0 | 7 | 1.18 | 0.080 |
| G5 | Comp. Ex. | 57 | 122 | — | ZnCl₂ | 111 | 99 | 1 | 0 | 7 | 1.14 | 0.113 |
| G6 | Ex. | 57 | 1 | Oleic acid | ZnCl₂ | 3 | 94 | 0 | 6 | 7 | 1.16 | 0.075 |
| F8 | Ex. | 57 | 3 | Oleic acid | ZnCl₂ | 18 | 93 | 0 | 7 | 7 | 1.17 | 0.075 |
| G7 | Ex. | 57 | 12 | Oleic acid | ZnCl₂ | 50 | 94 | 0 | 6 | 7 | 1.18 | 0.075 |
| G8 | Ex. | 57 | 24 | Oleic acid | ZnCl₂ | 70 | 94 | 0 | 6 | 7 | 1.19 | 0.076 |
| G9 | Ex. | 57 | 96 | Oleic acid | ZnCl₂ | 98 | 93 | 0 | 7 | 7 | 1.18 | 0.080 |
| G10 | Comp. Ex. | 57 | 122 | Oleic acid | ZnCl₂ | 109 | 93 | 0 | 7 | 7 | 1.12 | 0.120 |
| G11 | Ex. | 57 | 1 | Silane | ZnCl₂ | 1 | 94 | 3 | 3 | 7 | 1.17 | 0.074 |
| | | | | coupling | | | | | | | | |
| | | | | agent | | | | | | | | |
| F15 | Ex. | 57 | 3 | Silane | ZnCl₂ | 21 | 93 | 4 | 3 | 7 | 1.17 | 0.076 |
| | | | | coupling | | | | | | | | |
| | | | | agent | | | | | | | | |
| G12 | Ex. | 57 | 12 | Silane | ZnCl₂ | 49 | 93 | 4 | 3 | 7 | 1.17 | 0.078 |
| | | | | coupling | | | | | | | | |
| | | | | agent | | | | | | | | |
| G13 | Ex. | 57 | 24 | Silane | ZnCl₂ | 71 | 93 | 4 | 3 | 7 | 1.20 | 0.080 |
| | | | | coupling | | | | | | | | |
| | | | | agent | | | | | | | | |
| G14 | Ex. | 57 | 96 | Silane | ZnCl₂ | 99 | 92 | 4 | 4 | 7 | 1.21 | 0.080 |
| | | | | coupling | | | | | | | | |
| | | | | agent | | | | | | | | |
| G15 | Comp. Ex. | 57 | 122 | Silane | ZnCl₂ | 112 | 93 | 4 | 3 | 7 | 1.10 | 0.119 |
| | | | | coupling | | | | | | | | |
| | | | | agent | | | | | | | | |

Although the magnetic loss tended to increase as the mean particle size of the nanoparticles increased in Experiment 1 in which Zn was not added, the magnetic loss tended to be reduced in Examples of Experiment 6 shown in Table 8 due to the addition of Zn as compared with Experiment 1 (Table 1). From this result, it has been found that the magnetic loss in the high frequency band can be further reduced by adding the amphoteric metal. In addition, it has been also confirmed by XRD analysis that Zn is present as metal crystals in each of Examples of Experiment 6.

### Experiment 7

### Samples A21 and A22 (Examples)

In Samples A21 and A22, metal magnetic powders were manufactured under the same conditions as those for Sample A2 in Experiment 1, and then composite magnetic bodies were manufactured by media dispersion using a beads mill. In the media dispersion, ZrO₂ beads having a average size of 0.2 mm were used. A treatment time of the media dispersion in Sample A21 was 10 min, and a treatment time of the media dispersion in Sample A22 was 30 min. Manufacturing conditions other than the above were the same as those in Experiment 1.

### Samples E11 to E15 (Examples)

In Samples E11 to E15, ZnCl₂ was added after a lapse of a predetermined time from the start of the reaction. In each of Samples E11 to E15, a reaction temperature was set to 57° C., and a reaction time was set to 3 h. In Samples E11, E13 and E14, ZnCl₂ was added after a lapse of 1 h from the start of the reaction, and then, the reaction was further continued for 2 h. In Samples E12 and E15, ZnCl₂ was added after a lapse of 2 h from the start of the reaction, and then, the reaction was further continued for 1 h.

In Samples E11 to E12, composite magnetic bodies were manufactured by ultrasonic dispersion in the same manner as in Experiment 1 (that is, in the same manner as in Sample E5). On the other hand, composite magnetic bodies were manufactured by media dispersion using a beads mill in Samples E13 to E15. A treatment time of the media dispersion in Sample E13 was 10 min, and a treatment time in Samples E14 and E15 was 30 min. Manufacturing conditions other than the above were the same as those in Experiment 1.

Evaluation results of Examples of Experiment 7 are shown in Table 9. In Experiment 7, a cross section of the composite magnetic body was analyzed by mapping analysis using TEM-EDS, and the existing location of Zn was identified. In the item “Zn detection site” in Table 9, “Y” is written at a site where an amphoteric metal is detected, and “-” is written at a site where no amphoteric metal is detected. In each of Examples of Experiment 7, diffraction peaks of Zn were detected in an XRD pattern, and Zn was present as metal crystal grains.

TABLE 9

| | | | | | | Composite magnetic body | | | | | |
|---|---|---|---|---|---|---|---|---|---|---|---|
| | | Powder manufacturing conditions | | | | Dispersion conditions | | | | | |
| | | Reaction | | Additive | | | Treatment | Analysis result of Composite magnetic material | | | |
| | | temperature | Reaction | | Timing | | time | D50 | Ratio (%) | | |
| Sample Number | | (° C.) | time (h) | Type | (h) | Method | (min) | (nm) | hep-Co | fcc-Co | ε-Co |
| A2 | Ex. | 57 | 3 | — | — | Ultrasonic | 10 | 19 | 97 | 3 | 0 |
| A21 | Ex. | 57 | 3 | — | — | Media | 10 | 19 | 97 | 3 | 0 |
| A22 | Ex. | 57 | 3 | — | — | Media | 30 | 19 | 97 | 3 | 0 |
| E5 | Ex. | 57 | 3 | ZnCl₂ | 0 | Ultrasonic | 10 | 18 | 98 | 2 | 0 |
| E11 | Ex. | 57 | 3 | ZnCl₂ | 1 | Ultrasonic | 10 | 20 | 97 | 3 | 0 |
| E12 | Ex. | 57 | 3 | ZnCl₂ | 2 | Ultrasonic | 10 | 19 | 99 | 1 | 0 |
| E13 | Ex. | 57 | 3 | ZnCl₂ | 1 | Media | 10 | 21 | 98 | 2 | 0 |
| E14 | Ex. | 57 | 3 | ZnCl₂ | 1 | Media | 30 | 21 | 99 | 1 | 0 |
| E15 | Ex. | 57 | 3 | ZnCl₂ | 2 | Media | 30 | 20 | 97 | 3 | 0 |

| | Analysis result of Composite magnetic material | | | | | |
|---|---|---|---|---|---|---|
| | Content | Detection site of Zn | | | Magnetic properties | |
| | Ratio | Inside | Particle | In | μ′ | tanδ |
| Sample Number | of Zn (%) | particle | surface | resin | at 5 GHz | at 5 GHz |
| A2 | 0 | — | — | — | 1.17 | 0.072 |
| A21 | 0 | — | — | — | 1.17 | 0.071 |
| A22 | 0 | — | — | — | 1.17 | 0.072 |
| E5 | 7 | Y | — | — | 1.16 | 0.070 |
| E11 | 7 | Y | Y | — | 1.17 | 0.070 |
| E12 | 7 | — | Y | — | 1.16 | 0.069 |
| E13 | 7 | Y | Y | Y | 1.16 | 0.070 |
| E14 | 7 | Y | — | Y | 1.16 | 0.070 |
| E15 | 7 | — | — | Y | 1.17 | 0.071 |

From the results shown in Table 9, it has been found that the site where the amphoteric metal (Zn) is present can be controlled by a timing of adding a raw material of the amphoteric metal (ZnCl₂) and conditions of a dispersion treatment. Then, it has been confirmed that both a high permeability and a low magnetic loss could be achieved in a high frequency band even when the presence site of the amphoteric metal was changed.

### Experiment 8

In Experiment 8, a metal magnetic powder was manufactured under the same conditions as those for Sample B23 in Experiment 2, and then, the metal magnetic powder was subjected to a gradual oxidation treatment to obtain metal magnetic powders according to Samples B29 and B30. Conditions for the gradual oxidation treatment were controlled to make a content ratio of Co (W_{Co}) relative to 100 wt % of the metal magnetic powder have a value shown in Table 10. Since part of Co contained in the metal magnetic powder was oxidized by the gradual oxidation treatment, the metal magnetic powders in Samples B29 and B30 contained oxygen (O) in addition to Co (main component).

Composite magnetic bodies were also manufactured for Samples B29 and B30 in Experiment 8 under the same conditions as those for Sample B23 (that is, the conditions described in Experiment 1), and magnetic properties thereof were measured. Evaluation results of Experiment 8 are shown in Table 10. Note that the content ratio of Co shown in Table 10 was calculated by analyzing an XRD pattern of the composite magnetic body with X-ray analysis integrated software.

TABLE 10

| | | | | | Analysis result of metal magnetic powder | | | | | | |
|---|---|---|---|---|---|---|---|---|---|---|---|
| | | Powder manufacturing conditions | | | | | | | Content | | |
| | | Reaction | | | | | | | rate | Magnetic properties | |
| | | temperature | Reaction | | D50 | Ratio (%) | | | of Co | μ′ | tanδ |
| Sample No. | | (° C.) | time (h) | Additive | (nm) | hcp-Co | fcc-Co | ε-Co | (wt %) | at 5 GHz | at 5 GHz |
| B23 | Ex. | 150 | 2.5 | — | 52 | 53 | 47 | 0 | 93 | 1.24 | 0.086 |
| B29 | Ex. | 150 | 2.5 | — | 52 | 53 | 47 | 0 | 90 | 1.21 | 0.082 |
| B30 | Ex. | 150 | 2.5 | — | 52 | 53 | 47 | 0 | 80 | 1.15 | 0.075 |

As shown in Table 10, the same effects as those of Sample B23 could also be confirmed in Samples B29 and B30 in which the content ratio of Co was changed by the gradual oxidation treatment, and a magnetic loss could be reduced at 5 GHz as compared with the related art (Comparative Examples) while ensuring a high permeability.

### Experiment 9

In Experiment 9, metal magnetic powders were manufactured under the same conditions as those for Sample A2 in Experiment 1, and then, compounding ratios of the metal magnetic powders in composite magnetic bodies were changed to manufacture the composite magnetic bodies according to Samples A201 to A205. The compounding ratio of the metal magnetic powder in each of Samples A201 to A205 was controlled to make a content ratio of nanoparticles in the composite magnetic body have a value shown in Table 11. Manufacturing conditions other than the compounding ratio of the metal magnetic powder were the same as those for Sample A2.

In Experiment 9, composite magnetic bodies according to Samples C261 to C265 were manufactured as Comparative Examples. In each of Samples C261 to C265, a metal magnetic powder having ε-Co as a main phase was manufactured under the same conditions as those for Sample C26 (Comparative Example) of Experiment 2. Then, a compounding ratio of the metal magnetic powder was adjusted to make a content ratio of the nanoparticles in a composite magnetic body have a value shown in Table 11 to obtain the composite magnetic body. Manufacturing conditions other than the compounding ratio of the metal magnetic powder were the same as those for Sample C26.

In Experiment 9, a cross section of the manufactured composite magnetic body was observed with TEM, and an area ratio of the metal magnetic powder (nanoparticles) contained in the composite magnetic body was measured. As a result, it has been confirmed that the area ratio of the nanoparticles in each sample of Experiment 9 coincides with a target value (vol %) shown in Table 11.

In general, when a content ratio (packing rate) of the magnetic powder in the composite magnetic body is increased, a permeability increases, magnetic loss properties tend to deteriorate (that is, a magnetic loss increases). In Experiment 9, a criterion for determination of magnetic properties was provided for each content ratio of nanoparticles in consideration of a change in magnetic properties due to an increase or decrease in the packing rate. Specifically, a sample satisfying the following requirements was determined as “good” in Experiment 9.
number ratio of nanoparticles of 10 vol %: 1.15≤μ′, tanδ≤0.100
number ratio of nanoparticles of 20 vol %: 1.30≤μ′, tanδ≤0.150
number ratio of nanoparticles of 30 vol %: 1.45≤μ′, tanδ≤0.200
number ratio of nanoparticles of 40 vol %: 1.60≤μ′, tanδ≤0.250
number ratio of nanoparticles of 50 vol %: 1.75≤μ′, tanδ≤0.300
number ratio of nanoparticles of 60 vol %: 1.90≤μ′, tanδ≤0.350
Evaluation results of Experiment 9 are shown in Table 11.

TABLE 11

| | | | | | | | | | Composite | | |
|---|---|---|---|---|---|---|---|---|---|---|---|
| | | | | | | | | | magnetic body | | |
| | | Powder manufacturing conditions | | | | | | | Content | | |
| | | Reaction | | | Analysis result of metal magnetic powder | | | | ratio of | Magnetic properties | |
| | | temperature | Reaction | | D50 | Ratio (%) | | | nanoparticles | μ′ | tanδ |
| Sample Number | | (° C.) | time (h) | Additive | (nm) | hcp-Co | fcc-Co | ε-Co | (vol %) | at 5 GHz | at 5 GHz |
| C26 | Comp. Ex. | 180 | 1 | Oleic acid | 21 | 41 | 0 | 59 | 10 | 1.28 | 0.104 |
| C261 | Comp. Ex. | 180 | 1 | Oleic acid | 21 | 41 | 0 | 59 | 20 | 1.68 | 0.238 |
| C262 | Comp. Ex. | 180 | 1 | Oleic acid | 21 | 41 | 0 | 59 | 30 | 2.28 | 0.352 |
| C263 | Comp. Ex. | 180 | 1 | Oleic acid | 21 | 41 | 0 | 59 | 40 | 3.07 | 0.429 |
| C264 | Comp. Ex. | 180 | 1 | Oleic acid | 21 | 41 | 0 | 59 | 50 | 4.05 | 0.482 |
| C265 | Comp. Ex. | 180 | 1 | Oleic acid | 21 | 41 | 0 | 59 | 60 | 5.16 | 0.531 |
| A2 | Ex. | 57 | 3 | — | 19 | 97 | 3 | 0 | 10 | 1.17 | 0.072 |
| A201 | Ex. | 57 | 3 | — | 19 | 97 | 3 | 0 | 20 | 1.37 | 0.134 |
| A202 | Ex. | 57 | 3 | — | 19 | 97 | 3 | 0 | 30 | 1.61 | 0.188 |
| A203 | Ex. | 57 | 3 | — | 19 | 97 | 3 | 0 | 40 | 1.88 | 0.232 |
| A204 | Ex. | 57 | 3 | — | 19 | 97 | 3 | 0 | 50 | 2.19 | 0.269 |
| A205 | Comp. Ex. | 57 | 3 | — | 19 | 97 | 3 | 0 | 60 | 2.53 | 0.299 |

From the results shown in Table 11, even in Examples (Samples A201 to A205) in which the content ratio of nanoparticles in the composite magnetic body was changed, it was possible to reduce the magnetic loss as compared with the corresponding Comparative Examples (Samples C261 to C265) while ensuring the high permeability μ′.

### DESCRIPTION OF THE REFERENCE NUMERICAL

1 . . . metal magnetic powder
   2 . . . nanoparticle
   3, 3a, 3b, 3c . . . crystal grain of amphoteric metal
10 . . . composite magnetic body
   6 . . . resin
100 . . . inductor
   50 . . . coil portion
   60, 80 . . . external electrode

What is claimed is:

1. A metal magnetic powder comprising Co as a main component,
wherein the metal magnetic powder comprises metal nanoparticles having a mean particle size (D50) of 1 nm or more and 100 nm or less,
wherein each of the metal nanoparticles comprises hcp-Co as a main phase, and
wherein the metal magnetic powder includes fcc-Co and/or ε-Co as a sub-phase.

2. The metal magnetic powder according to claim 1, wherein
W_{hcp}/(W_{hcp}+W_{fcc}+W_{ε}) is 70% or more and 99% or less
where W_{hcp} denotes a proportion of the hcp-Co, W_{fcc} denotes a proportion of the fcc-Co, and W_{ε} denotes a proportion of the ε-Co, in the metal magnetic powder.

3. The metal magnetic powder according to claim 1, wherein the metal nanoparticles have a mean particle size (D50) of 1 nm or more and 70 nm or less.

4. The metal magnetic powder according to claim 1, further comprising Zn,
wherein Zn is present on a surface and/or inside of at least one of the metal nanoparticles.

5. A composite magnetic body comprising the metal magnetic powder according to claim 1 and a resin.

6. The composite magnetic body according to claim 5, further comprising Zn.

7. An electronic component comprising the metal magnetic powder according to claim 1.

8. An electronic component comprising the composite magnetic body according to claim 5.
